(19) United States
(12) Patent Application Publication
(10) Pub. No.: US 2014/0101533 A1
(43) Pub. Date: Apr. 10, 2014

(54) LOSSLESS APPLICATION OF NEW INFORMATION ARCHITECTURE TO EXISTING WEBSITES, WEB PAGES, AND ONLINE CONTENT

(71) Applicant: PERCUSSION SOFTWARE, INC., Woburn, MA (US)

(72) Inventors: Vernon IMRICH, Reading, MA (US); Lorena PROIA, Somerville, MA (US); Jay SELETZ, FRAMINGHAM, MA (US); Bhuvaneshwar JOGINIPALLY, North Andover, MA (US); Yu-Bing CHEN, Wayland, MA (US); Paul HOWARD, Denver, CO (US)

(73) Assignee: PERCUSSION SOFTWARE, INC., Woburn, MA (US)

(21) Appl. No.: 14/043,019

(22) Filed: Oct. 1, 2013

Related U.S. Application Data
(60) Provisional application No. 61/744,680, filed on Oct. 2, 2012.

(51) Int. Cl. G06F 17/24

(52) U.S. Cl. CPC G06F 17/248
USPC 715/234

(57) ABSTRACT

A method and system that applies an information architecture (IA) to an existing website, set of web pages, or other online content. The method and system may allow a user to apply IA to web pages in situ, and through a visual point and click process. This prevents the loss of content and/or look and feel as IA changes are being applied, provides immediate visual feedback to the user, dramatically reducing the skill required to make IA choices, and makes subsequent content migration and/or “reassembly” of websites or pages unnecessary.

### CROSS REFERENCE TO RELATED APPLICATIONS

This application claims priority from U.S. Provisional Application Ser. No. 61/744,680 filed Oct. 2, 2012, the entirety of which is incorporated herein by reference.

### FIELD OF THE INVENTION

Embodiments of the invention relate to the lossless application of new information architecture to an existing website, web pages or other collection of online content.

### BACKGROUND

The Information Architecture Institute defines “information architecture” as “the art and science of organizing and labeling websites, intranets, online communities and software to support usability.” The application of information architecture to a website enhances the usability of software applications such as e.g., content management systems, that enable editing, creation, and management of websites and online communication channels delivered over the web. The enhanced usability of the resulting software systems allows many more users to participate in the production of websites and more general online content, allowing organizations to dramatically reduce the cost and increase the speed of online content production.

The challenge today, however, is that application of information architecture (hereafter referred to as “IA”) to an existing website or collection of online content, requires an expert skill level in the art, as well as a lengthy manual process in which the website or content is decomposed into constituent parts and then reassembled. Because the process is manual, it often introduces data loss including: (1) reassembled pages that do not look the same as the original; (2) site styles defining the look and feel, such as CSS, that must be dramatically edited or re-created from scratch; and (3) site content may be left out or returned to the wrong location during reassembly. Expensive content migration tools and processes are often required. Because the goal of the process is increased usability, expertise is required to make IA choices that most help users. Finally, due to the high rate of change of web technology, websites and online content are constantly changing. This requires commensurate ongoing re-application of IA to these online properties. The skill and cost of current IA application processes and techniques are too high to be effective.

Accordingly, there is a need and desire for a better technique for applying an information architecture to e.g., an existing website or collection of online content.

### SUMMARY OF THE INVENTION

A new method and system that applies an information architecture to an existing website, set of web pages, or other online content is described herein. The method and system may allow a user to apply IA to web pages in situ, and through a visual point and click process. This prevents loss of content and “look and feel” as IA changes are being applied, provides immediate visual feedback to the user, dramatically reducing the skill required to make IA choices, and makes subsequent content migration and/or “reassembly” of websites or pages unnecessary.

### BRIEF DESCRIPTION OF THE DRAWINGS

FIG. 1 is a flowchart illustrating an example process according to one embodiment disclosed herein.

FIG. 2a is a flowchart illustrating an example of outside-in-top-down process to determine where the possible next layer of IA can or must be applied according to one embodiment disclosed herein.

FIG. 2b is an example HTML hierarchy.

FIG. 3 is an example flow diagram illustrating possible user interaction with the disclosed system and method.

FIGS. 4-37 illustrate screen shots during the application of information architecture to a web site in accordance with an embodiment disclosed herein.

FIG. 38 shows an example of a catalog of possible page groups in accordance with a disclosed embodiment.

FIG. 39 shows an example of a user inspecting a group of pages in accordance with a disclosed embodiment.

FIG. 40 shows an example of a user manually moving a page from one group to another in accordance with a disclosed embodiment.

FIG. 41 illustrates an example environment in which the disclosed process may be implemented.

### DETAILED DESCRIPTION

The lossless application of new information architecture to an existing web site, pages or other collection of online content, enables software applications, such as content management systems, to improve management and editing of website content and control over existing website design (look and feel), without requiring lengthy and expensive manual site decomposition and reconstruction where content or design is often lost. Furthermore, the lossless application of information architecture enables ongoing reapplication of new information architecture to websites that are already being managed by software applications such as content management systems, enabling ongoing rapid improvement of site information architecture faster, and at far lower cost than existing manual methods since loss of content or design is prevented. Embodiments of the invention impose an ordered process that eliminates any loss of existing website content or look and feel as the new information architecture is applied, improve the choices that users make about information architecture by allowing them to see the impact of each change to information architecture on both content and design before continuing, automate the application of information architecture to the entire site based on selections made for one or a few representative pages, and both impose limits and make suggestions for information architecture changes at each step based on an analysis of representative pages so as to eliminate loss of content or look and feel.

Various embodiments may include some or all of the following aspects. In one embodiment, an in situ visual step-by-step process is provided. This process will include (a) providing a visual “in situ” interface for application of the IA to a web page so that a human user with basic web skills can easily make choices to optimize the benefit of the IA—such as better editing of page content, better control over display, better control over content reuse; (b) imposing an ordered process (e.g., a set of recursive steps) so that the user can see the impact of his or her IA choices in a series of iterative testable selection steps. This eliminates troubleshooting and guesswork resulting from other approaches to IA application, and improves each subsequent IA choice the user makes as he or she proceeds; (c) Analyzing the site and page and determining the possible next step or set of choices that can be made to page elements so that a new IA can be applied without loss of existing look and feel or content of the page due to the changes; and (d) automating or suggesting IA choices at each step based on the analysis of internal HTML structures and the goal(s) of the IA. This further reduces the skill required to make IA choices, which maximizes the number of users who can edit parts of a page while also allowing designers to retain control over layout and common look and feel for the remainder of the page. The process also provides the user with the ability to override suggestions.

In another embodiment, a bulk automated process is provided. This process will include: (a) automating the subsequent page and site changes needed in order to apply the new IA choices, yet ensures no loss of existing look and feel or loss of content due to these IA changes; (b) applying the IA choices made on one page to many other pages (as selected), ensuring no loss of either look and feel or content on these pages due to the new IA changes being applied (excepting losses that are desired as part of the new IA); (c) allowing for ongoing incremental changes to the IA of many pages due to changes made on a single selected page (as desired). These changes are applied without loss of existing look and feel or content due to these IA changes; (d) after a page is used to create a new IA, automating/suggesting other pages to apply this new or modified IA to based on how similar these other pages are to the current page being processed. The process also provides the user with the ability to override suggestions.

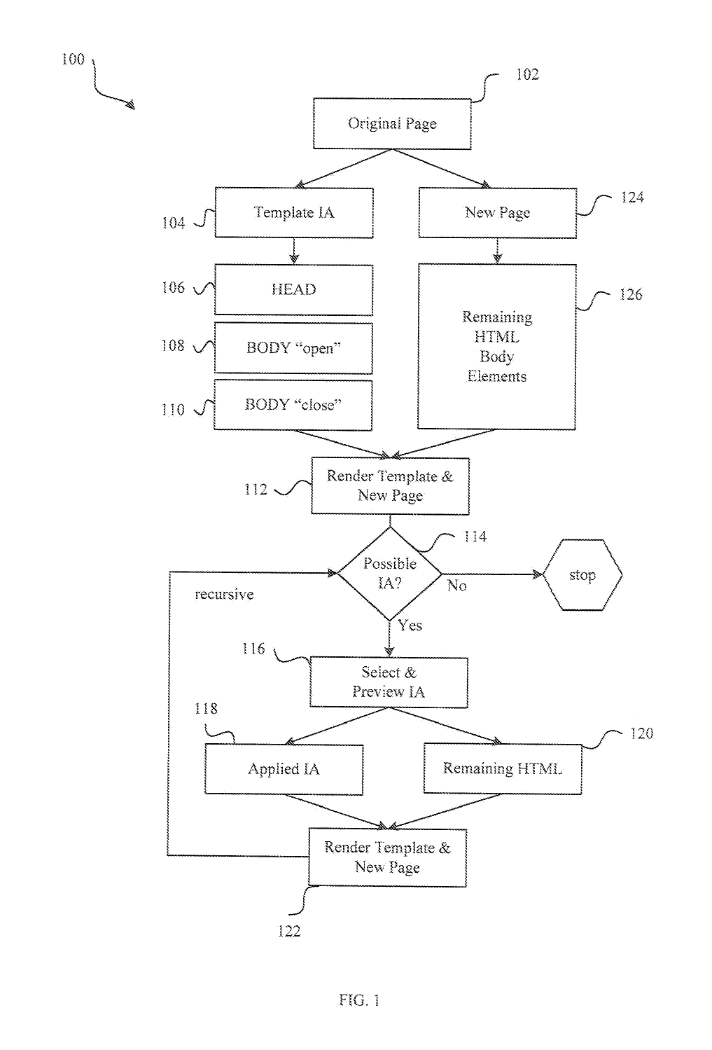

FIG. 1 is a flowchart illustrating the process 100 according to one embodiment. The process 100 comprises two parts. It should be appreciated that the process may be implemented as a software application that may be run on a data processing device such as e.g., a server.

The first part of the process (i.e., “part I”) includes the creation of new IA in a template using an existing HTML Page. Initially, the user is allowed to select any existing page via e.g., a URL. The page is retrieved and imported (block 102). The page is then split into a “template” object (block 104) and a page object (block 124). The template object is stored separately from the page so that it can later be applied to many pages. The page head and body are parsed to find and retrieve all needed files for page rendering (e.g., css, background images, images, javascript files, other linked files). In addition or optionally, for external sources referenced by the current page, the process ensures that the correct links to preserve rendering (block 126).

Continuing, the page head element is separated from body element and the page head element is transferred to the template (block 106). The page head element is not directly rendered by the browser, so it must be separated into the IA to facilitate usability of page editing. However, the page head includes references to “theme” files that control look and feel and other interactions in the browser display of the page including e.g. CSS, JavaScript, and other HTML markups. The page body element is directly rendered by the browser, so it can be processed further with in situ visual interactions.

The process 100 separates script tags and any non-rendering markup that exists between the HTML body open tag (block 108) and the first rendering HTML element inside the body. The same process is performed for any markup between the last rendering element and the closing tag (block 110) of the body element. This markup is stored in the template and removed from the page so that it can be part of the IA applied to all pages. Non-rendering elements and markup perform similar functions as markup in the HTML head. They need to be preserved to ensure the page's look and feel and other interactive browser behaviors, but removed from the page selection visuals to come.

The process 100 renders the page using the template to ensure that no loss of visual fidelity has occurred due to the initial separation of some page elements into the template while leaving others in the page (block 112). For the current page, based on the html element hierarchy at the current step in the process, the process determines the possible set of elements that can be used to add IA organization, labels and structure to existing pages without introducing loss, look and feel, or content (block 114). Because the rendering of the HTML page in a browser follows a “flow” model from top to bottom, the selection must match this flow. The embodiment of this process follows an “outside in and top down” selection rule in which the outermost elements must all be processed first, within a level, the top most sibling elements are processed before the bottom elements, and so on through the hierarchical structure.

It is desirable that the element used to add IA markup to the page must not alter existing page rendering or content. Certain HTML elements, including DIV tags, may be used, as they are specified to be neutral to most page rendering and content meaning. However, whatever element or markup is used, the system must ensure, such as by adding CSS styles (e.g., setting borders to none and margins to zero), that any added element or markup does not change the page's look and feel when the new element used to add IA description is persisted in the output pages.

The process 100 allow the user to select an element (block 116). This step may include temporarily altering the visual display of the elements that the user will be allowed to select so the user can see which ones are possible to select for IA purposes, and providing an interaction mechanism (such as a click event) that the user can take to make a selection of an element. In addition, block 116 allows the user to select one or more possible elements and see the result of making that selected element part of the new IA structure. To prevent loss, the sibling elements to the selection must be changed to have a corresponding IA markup. The preview of this change will help the user see how the organization of one element will impact the nearby elements at the same level.

The process 100 applies the selected change in situ (block 118), but keeps the IA in the template (while content is in the page) to eliminate possible loss. This step should: (a) add the new IA markup to the template, not the page; (b) break up the html of the current page so that it matches the correct display locations in the template based on the IA that was added to the template and the visual selection made by the user interacting with the page (block 120). That is, when the page is seen through the template, the html inside the selected page element must appear inside the corresponding template IA markup that was added; (c) show the resulting page and template displayed together, showing both IA and page content in one visual display.

The process 100 then renders the page through the template, in situ (block 122). The page is altered and the user is allowed to see that no loss in content or display has occurred due to new IA markup being added to the template. In some cases, the user may desire a change to the display rules or behaviors of the page as part of this application. This step allows the user to make optional minor alterations to the display rules in e.g., CSS or other html in the template before proceeding. The process 100 allows the user to proceed to the next sibling element in the same level of the hierarchy, repeating the above steps. The process 100 allows the user to proceed to the next set of inner “child” elements of any previously processed outer element above, repeating the above steps at that new inner level of the element hierarchy.

As shown in FIG. 1, the user may stop at any time. The result of the process 100 is a template with added IA markup that facilitates page structure and usability for editing or changing page content or creating new pages. However, the page used to create this IA in the template has been decomposed into a set of HTML elements during the process that ensure no loss to page content or look and feel has occurred. As can be appreciated, this process may be initiated again (later) on any page-template pair previously created, starting at the step where the page is first rendered in the template (i.e., block 112).

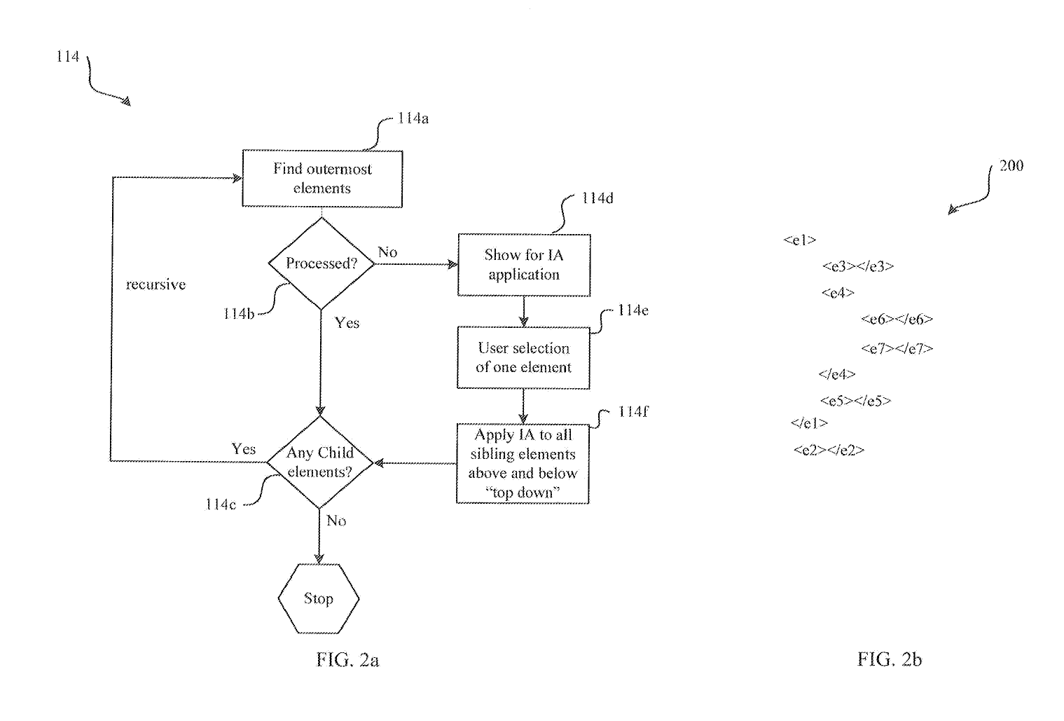

FIG. 2a is a flowchart illustrating an example of outside-in-top-down processing (block 114) to determine where the possible next layer of IA can or must be applied according to one embodiment. As can be seen, the outermost elements are found (block 114a) and then checked to see if they will be processed (block 114b). If not, the they are shown to the user for IA (block 114d). If the user selects one of the elements (block 114e), the IA will be applied to all sibling elements above and below the selected element in a “top down” manner (block 114f). A check is made to see if there are any child elements (block 114c). This can occur after block 114f or block 114b. If there are child elements, the process 114 continues at block 114a.

FIG. 2b illustrates an HTML element hierarchy 200 in which actual HTML element names have been replaced with generic names “e1” to “e7” for simplicity (it should be appreciated that the actual HTML elements are not important, just the disclosed structure). In the illustrated example, elements e1 and e2 start out as the outermost in the hierarchy. The user would only see these as possible elements to apply IA to if they had not yet been processed. Further, to enforce “top down” processing, when either e1 or e2 is selected, the IA will be applied to both e1 and e2 so that all elements from top to bottom at that level are processed before the next step is allowed. Elements e3, e4 and e5 (but not e6 or e7) would be available for processing as the next outermost. If any element e3, e4, or e5 is selected, IA will be applied to all three to ensure a “top down” of that level of elements is processed before continuing. Finally, e6 and e7 could be selected and processed.

The second part (i.e., “part II”) of the novel process disclosed herein includes the bulk application of the IA to other pages. To facilitate this part of the process, a copy of the original page is kept during block 120 (discussed above) and wherever else the original page is modified to fit the template being created. Where the original page is broken up into new IA elements stored in a template and the remaining HTML elements are stored at the page level, the copy of the original page is only annotated with markup indicating where the resulting HTML “page level” blocks are. It should be noted that there is no need to store or remember the transformation processes or choices made at steps that led to a block of HTML being left in the page. Only the remaining HTML block left at the page level (at any step) needs to be marked. In addition, a wide variety of markup may be used at this point to annotate the copy of the original page since this copy is not used for rendering.

The bulk application process allows the user to select an IA (template) created e.g., as discussed above (e.g., the in situ processing). The user is allowed to select other pages (either in or out of the application) on which to apply the IA created as discussed above. The annotated copy of the original page that was used to create the selected IA template is retrieved. From that page, a set of html element path identifiers are defined based on where the IA was added to the original page. As HTML is a hierarchical structure, the “path” to an element describes how to find any element (or block of elements) in the structure. XPath and CSS Selectors, for example, provide two standards that define a path to an HTML element.

For each page selected by the user, the set of paths created above are used to extract all of the matching HTML elements from the page being processed. A new page object is created in the application consisting only of these matching HTML elements, leaving out all the rest of the page HTML (including the page head element and non-rendering elements after the body open and before the body close, and other elements that do not match).

A new set of page objects now exist that represent pages that have only the HTML elements needed by the selected IA template. When any of these new pages are rendered through the selected IA template, they will conform to the desired IA as much as possible. Then, an improved selection process is used to minimize loss. This process (a) allows the user to select a template IA and retrieve the annotated copy of the original page used to create it; (b) inventories (i.e., makes a determination of) all possible pages on a web site or in a file or other location where many pages exist; (c) compares each page in the set of possible pages above to the annotated copy of the original page; (d) shows the user an ordered list of possible pages based on how similar they are to the annotated copy of the original page.

The user may now decide only to apply the template IA to the pages that were most similar to the original page used to create the template IA. For example, by repeating some of the above steps for each set of selected pages, the user can determine when to stop the application of the template IA or even throw away the results if too much content or look and feel is lost. At any point, the user may select a page from the list of possible pages that did not match well to the selected template IA (discussed above). This unprocessed page may be used to create another new template IA by repeating the in situ process discussed above for the unprocessed page. Then, the bulk application process is applied to that new template IA. The part I and part II processed are repeated until all possible pages are processed.

The improved selection process can be replaced by, or supplemented by, a site wide catalog process. A site wide catalog process includes, for a given set of possible pages (in a website, folder or other collection of pages), (a) comparing the structure of each page to all the pages; (b) determining how similar any page is to each of the others; (c) creating a catalog of pages consisting of groups of pages based on their similarity rating to other pages in the group. How similar a page must be to other pages in a group can be a value adjusted by the user so that more or fewer groups of pages are created. A high similarity score will create a catalog with many groups with few pages each. A low value will create a catalog with fewer groups with more pages in each group. Similarity ratings may be based on the number of common elements in the pages. In some embodiments, the common elements may be weighted by IA level, with outermost elements being weighted more heavily than innermost elements. In some embodiments, common elements may also be weighted by type (e.g., paragraph, title, etc.); (d) for each group of pages that share similarity to each other, suggesting that the user select one page to use in part I to create a template IA, then suggesting that the user apply that template only to pages in that group; (e) suggesting that the user continue with each group until all groups in the catalog are processed.

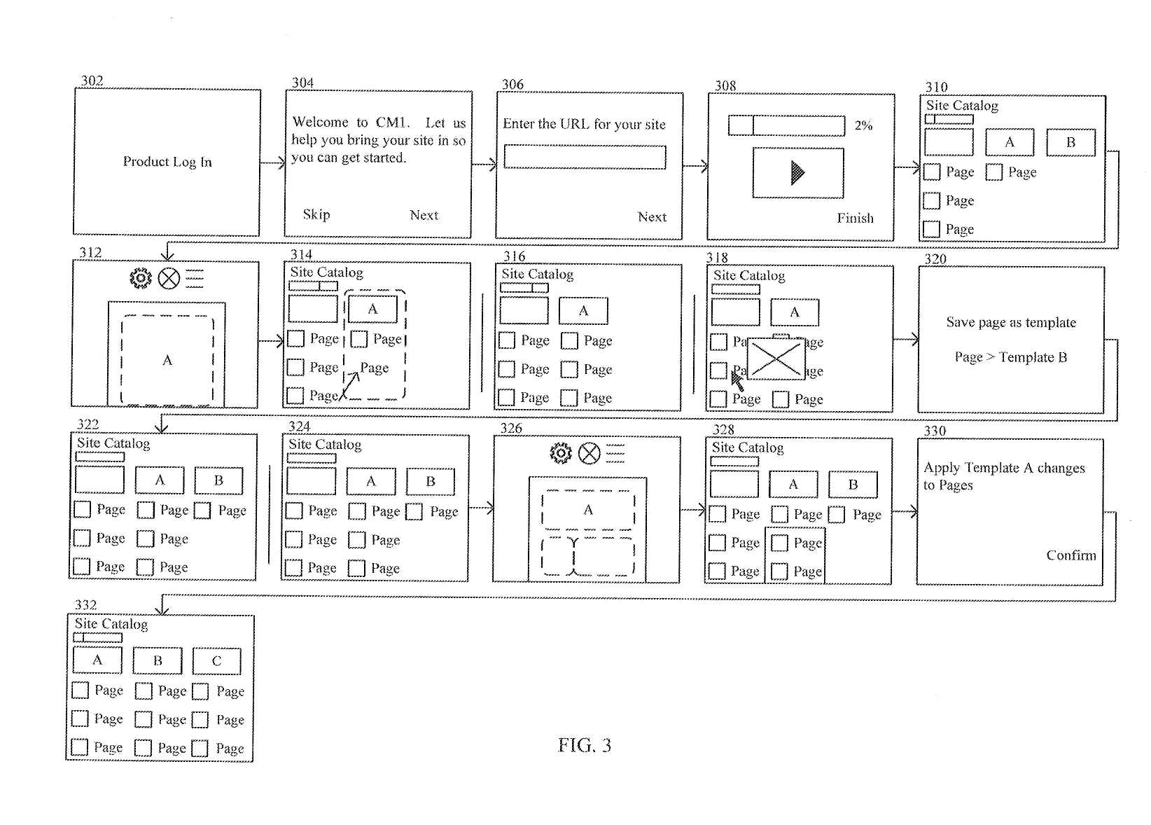

FIG. 3 is a flow diagram illustrating example user interaction during the above processing. The user may work on a page to convert it into a template IA, or apply a previously completed template IA to a set of pages as found in the catalog. The user can use the suggested catalog page groups (e.g., A through E) created in the catalog process, or make their own selection and apply the template to those pages. For example, at block 302, the user inputs its email address and password to log into the process. The user sees a welcome screen/wizard that is the first step of the import process (block 304). The users enters the URL for the site he/she wishes to import (block 306). The user views the import progress for the site home page and views a video explaining the next step in the site import process (block 308). The user navigates to the site catalog where he/she can see the progress of the import process, the list of catalogued and imported pages, and the homepage and homepage template (block 310).

Continuing, the user may navigate to the template to break it down into regions and widgets (block 312). The user may navigate back to the catalog to assign pages to the newly modified template (block 314). At any time, the user can navigate to the site catalog to view the status of the import process (block 316). The user can view a thumbnail snapshot of pages that have been imported into the system (block 318). The user can choose a page and convert the imported page into a template/model for other pages (block 320). The user sees the template selected in block 320 in the list of templates and sees the page assigned to that template (block 322). At that point, the user can assign pages to that template.

The user can navigate to a catalog of templates and see the pages that have been assigned to each template (block 324). The user can choose to make further modifications to the template (block 326). The user can return to the catalog and see the pages assigned to the template that must have the template modifications applied to them (block 328). The user chooses to apply the template changes to the pages (block 330). The user sees the list of pages with no visual indication that changes must be applied (page 332).

### Application Example

Part I

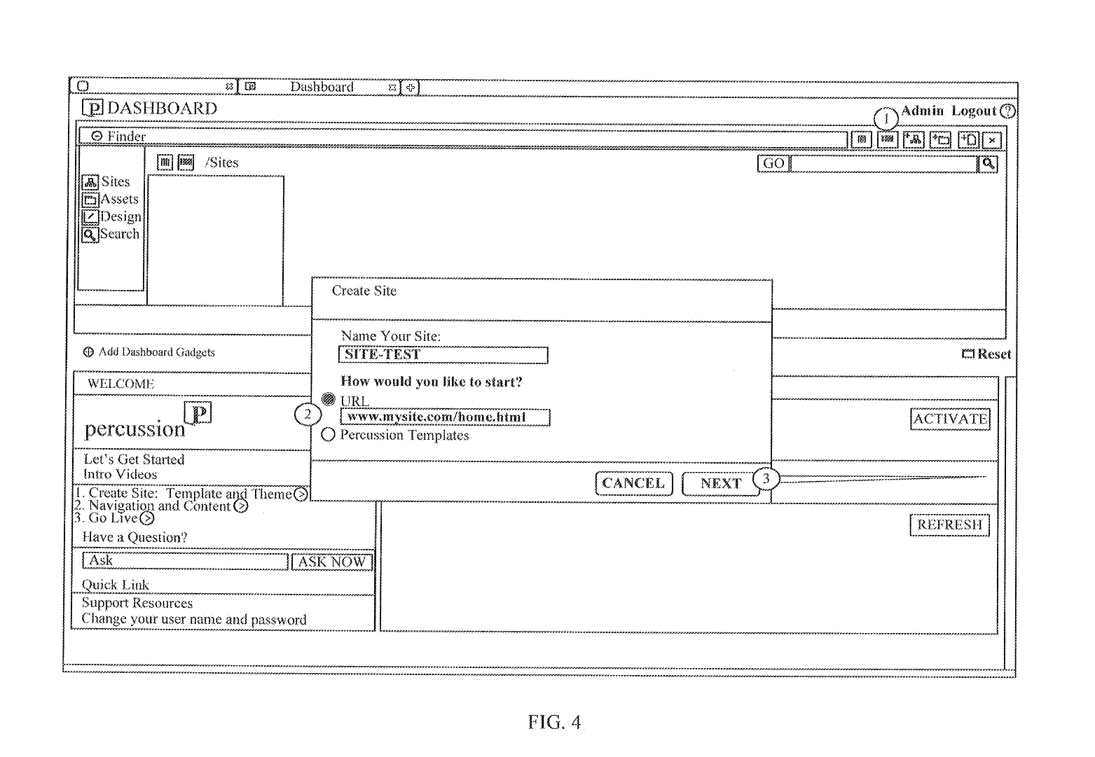

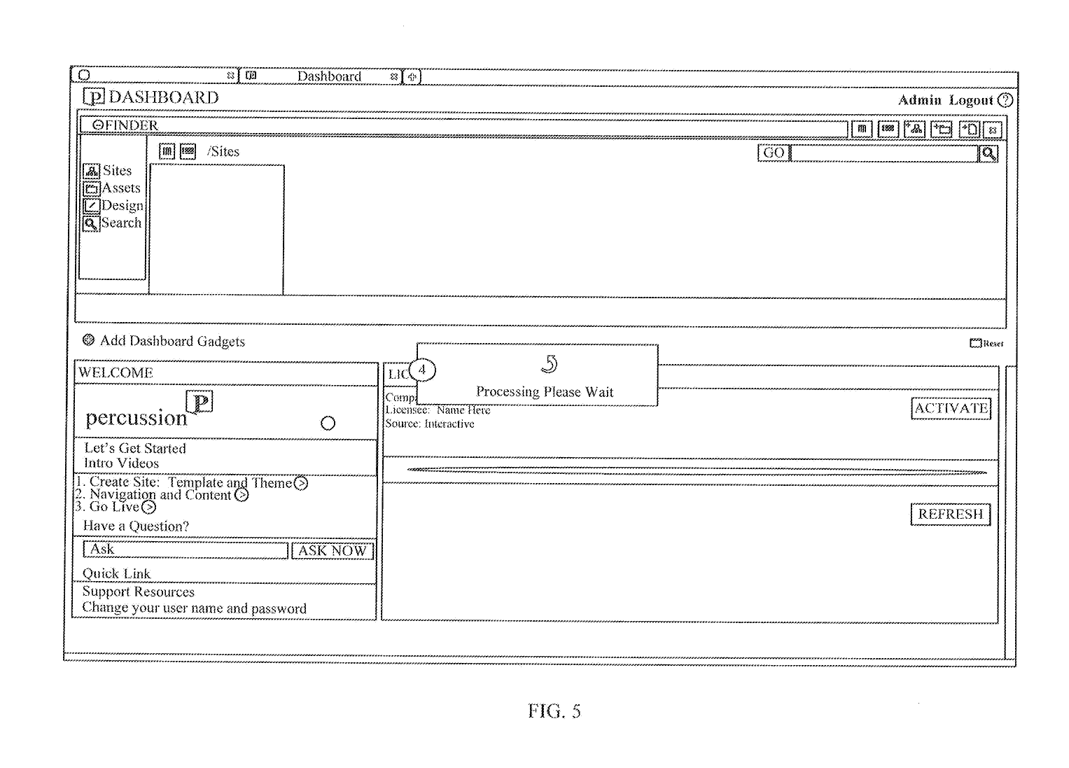

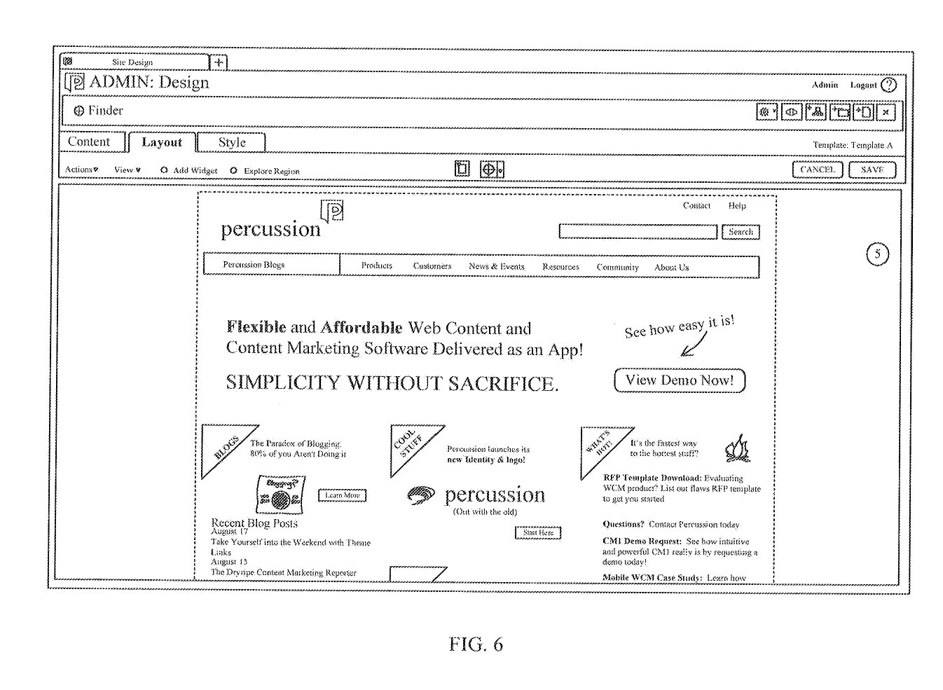

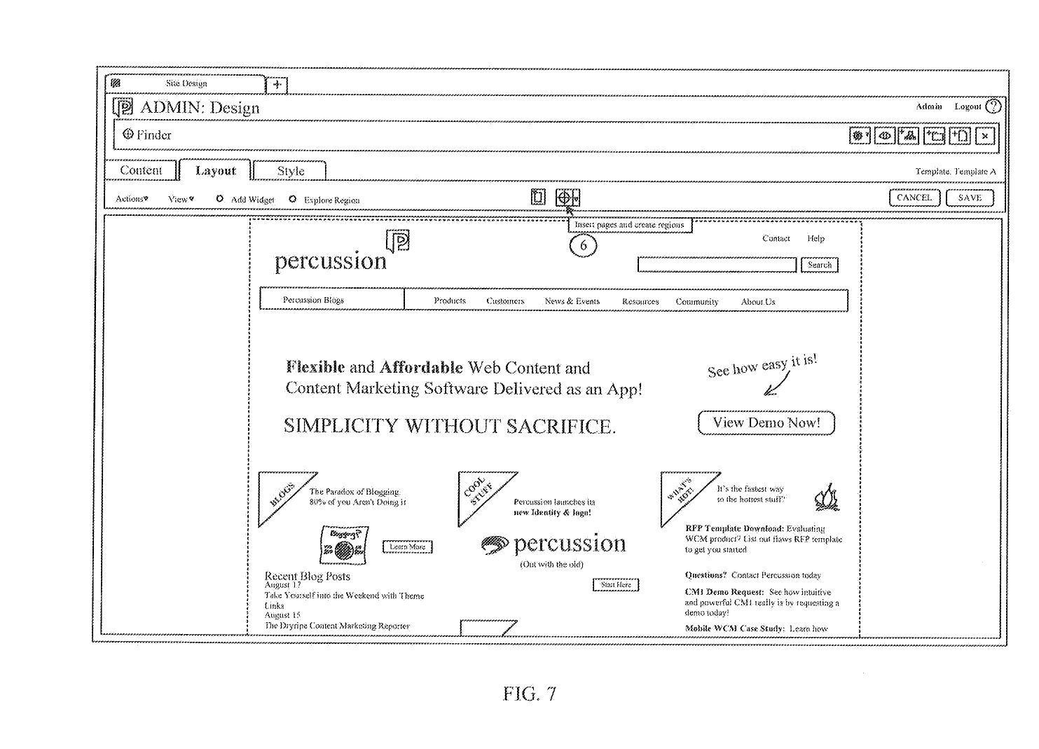

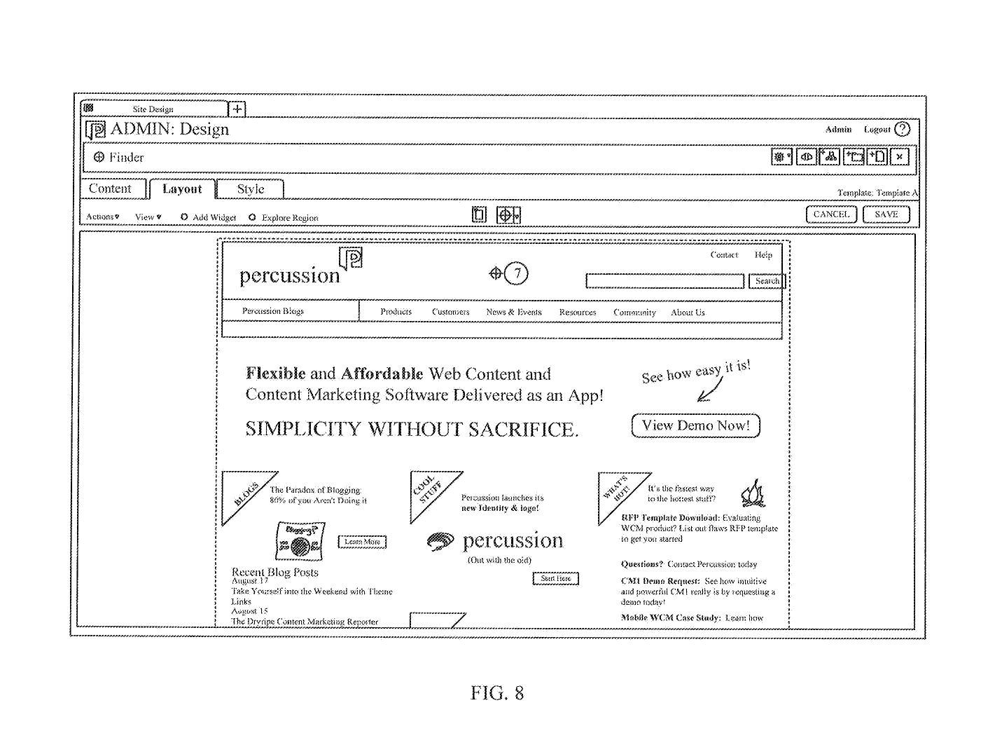

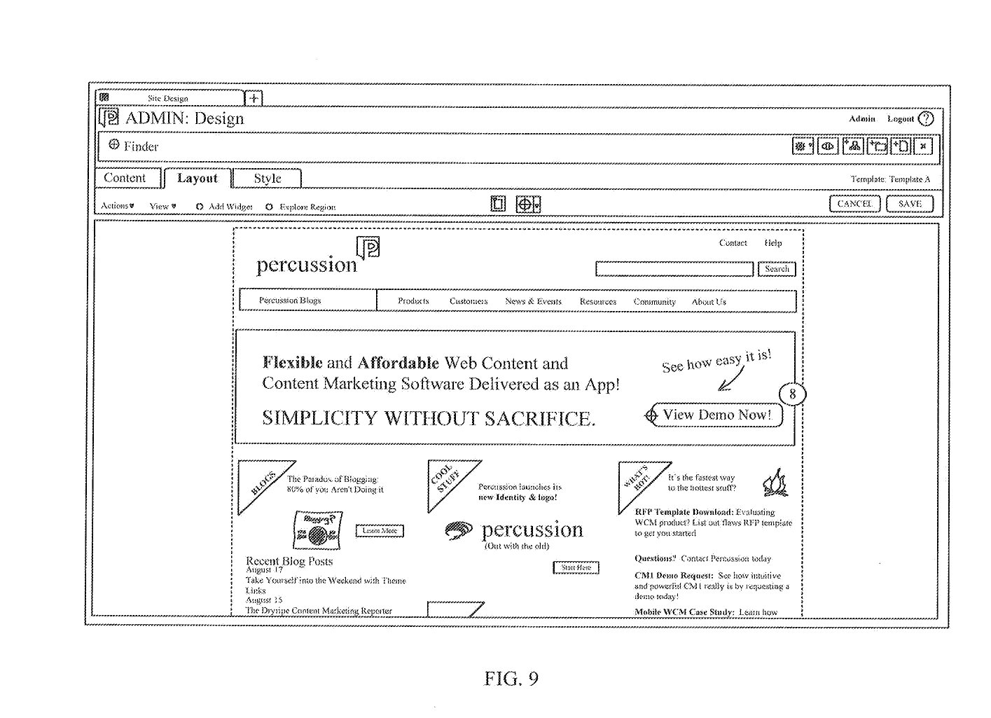

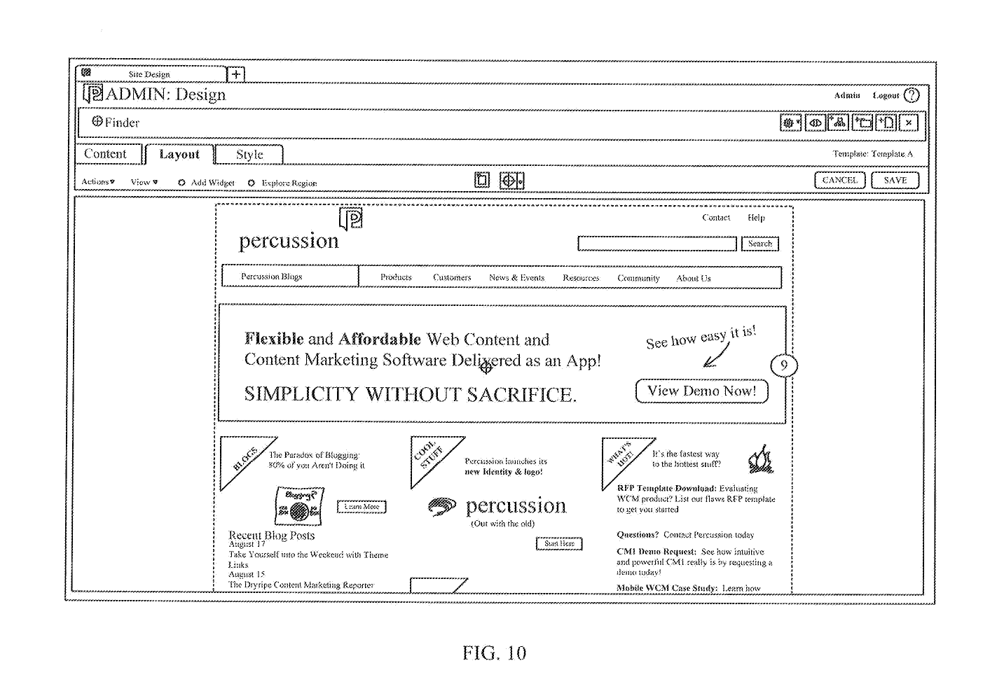

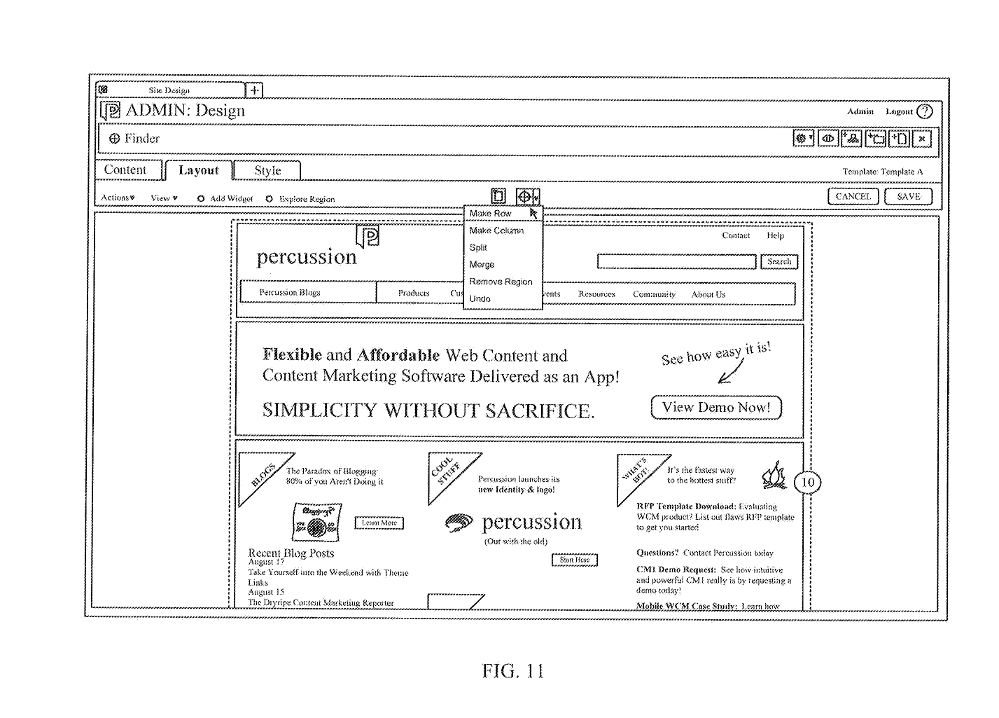

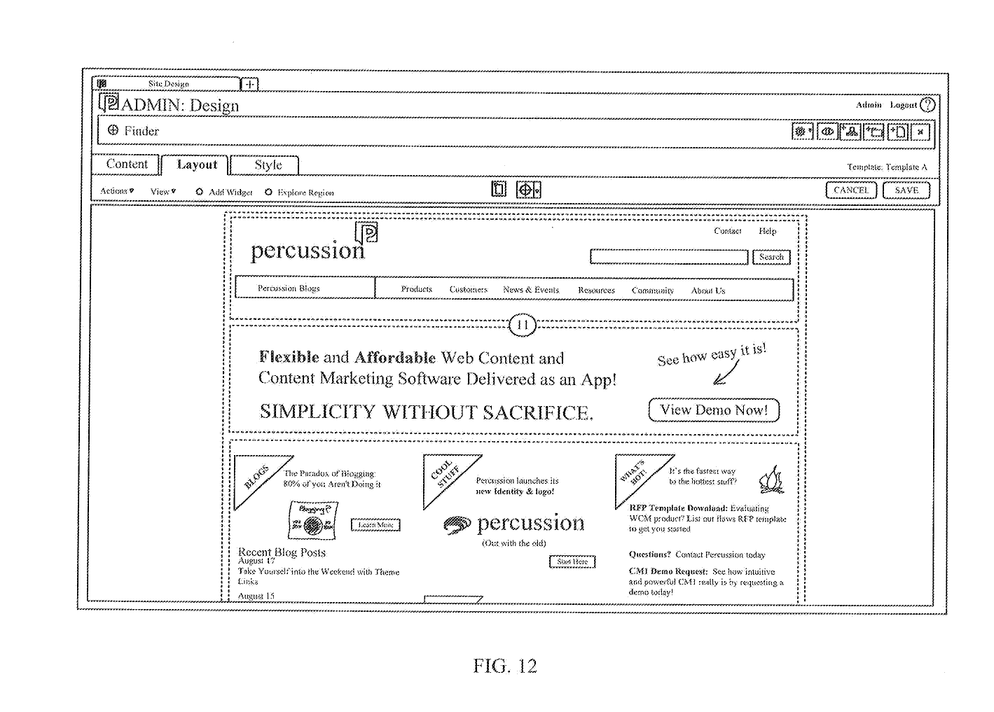

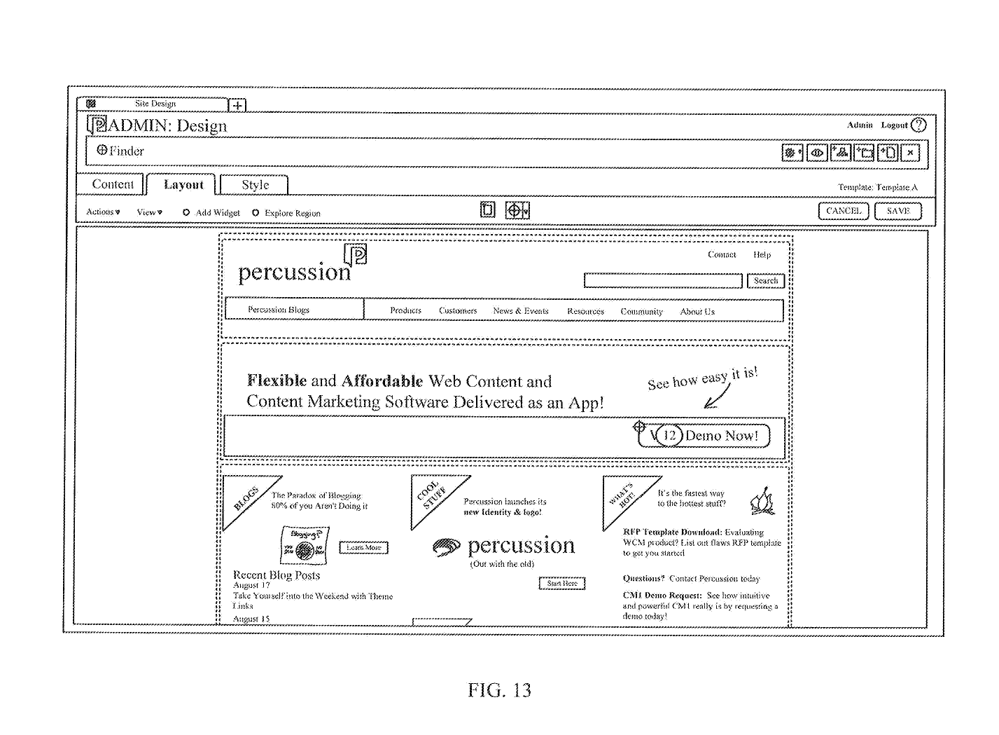

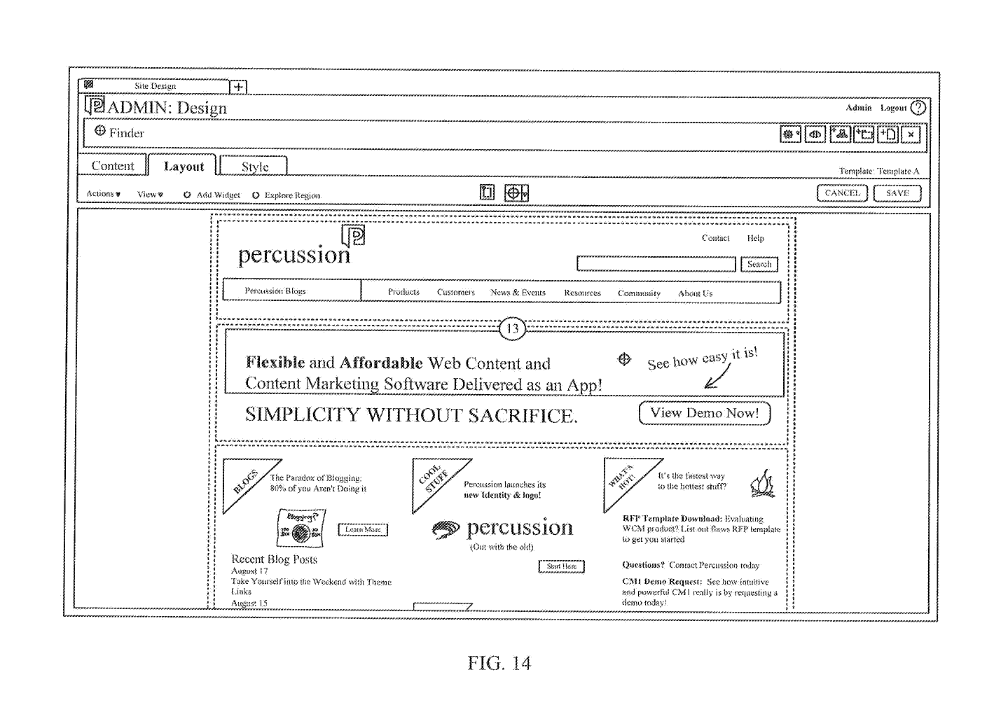

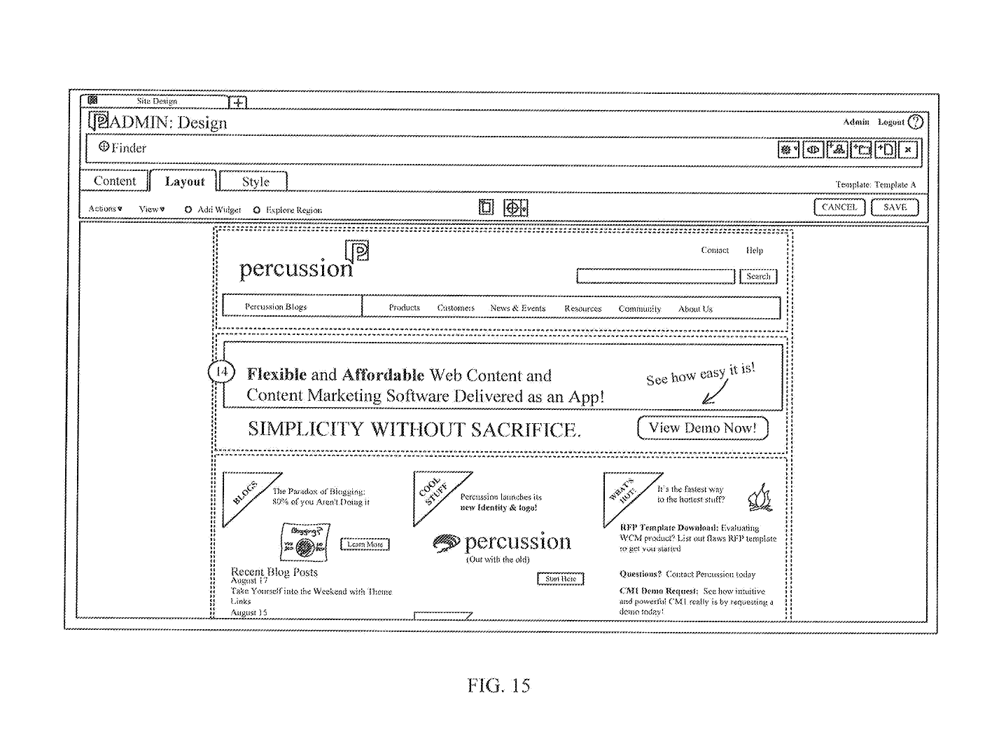

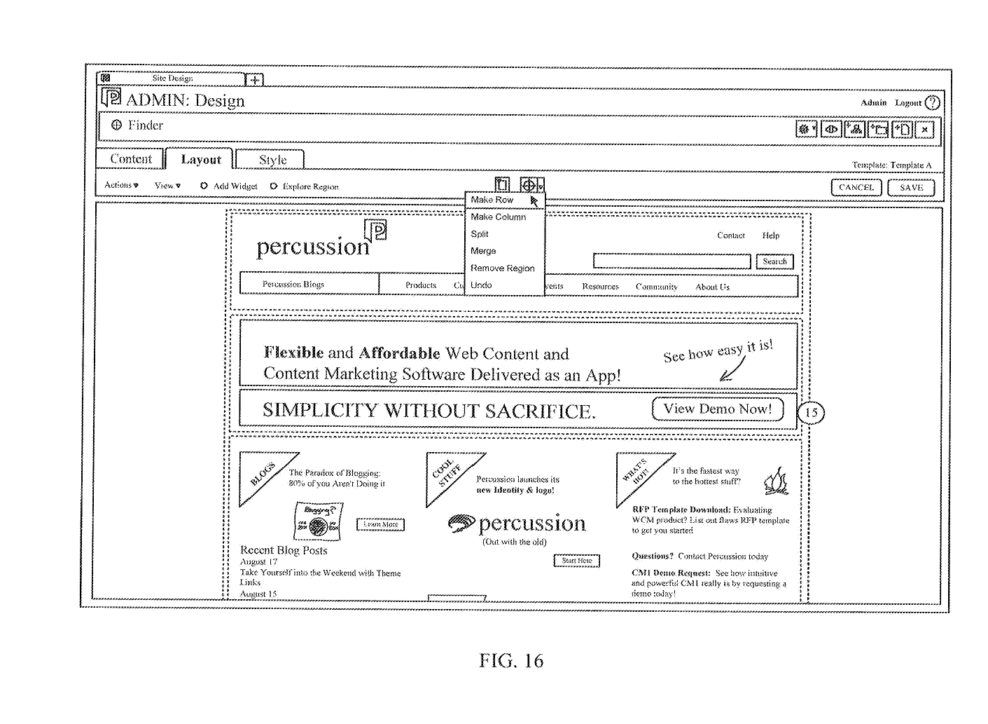

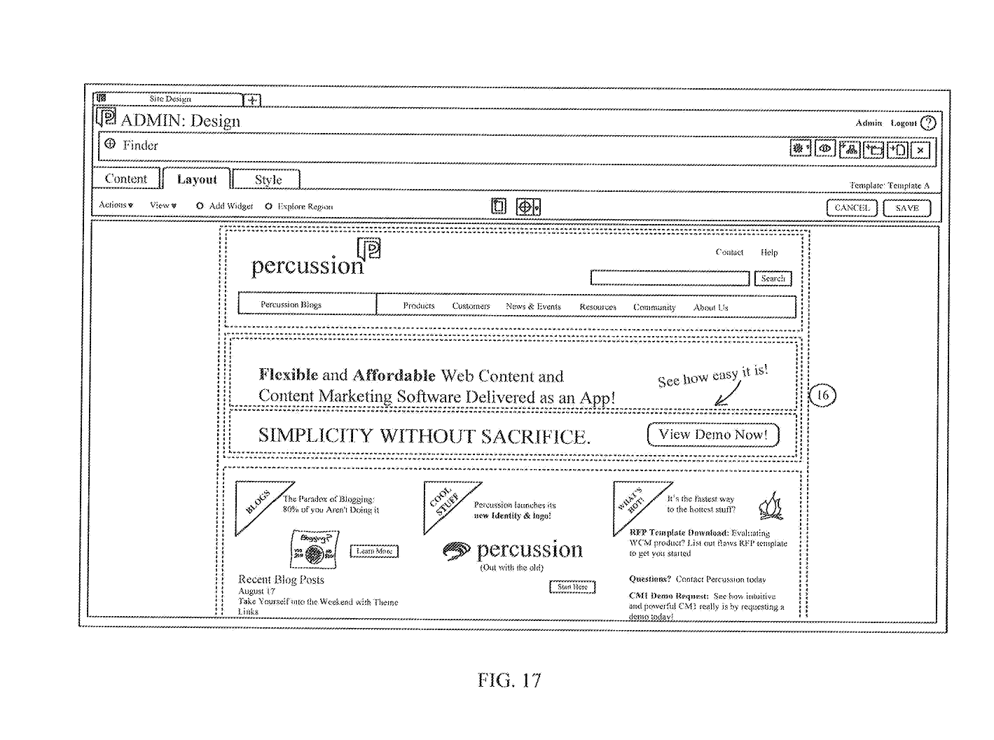

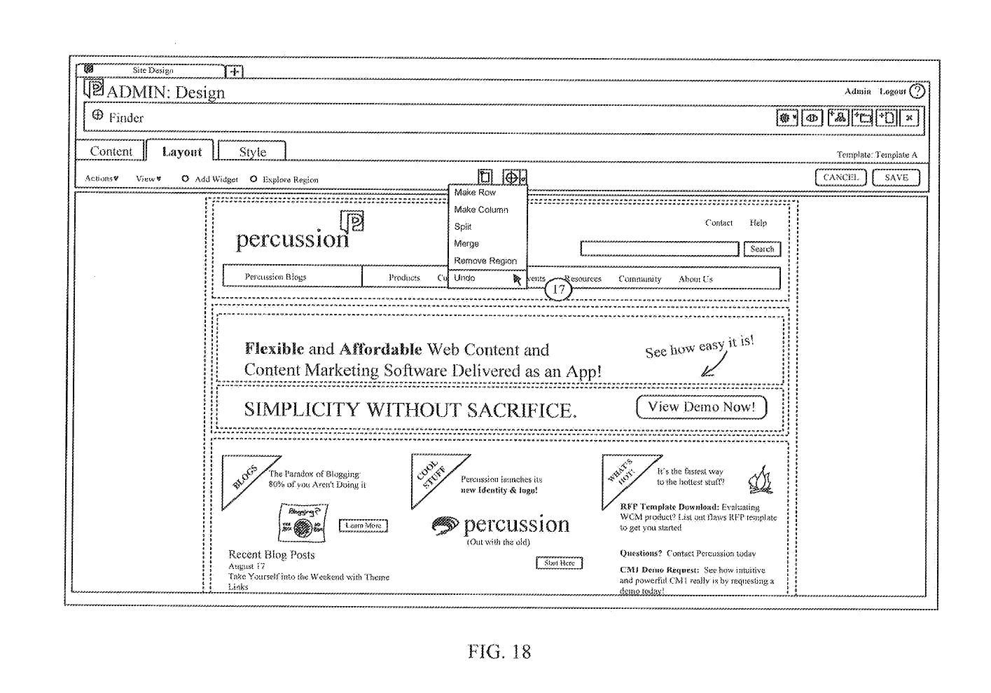

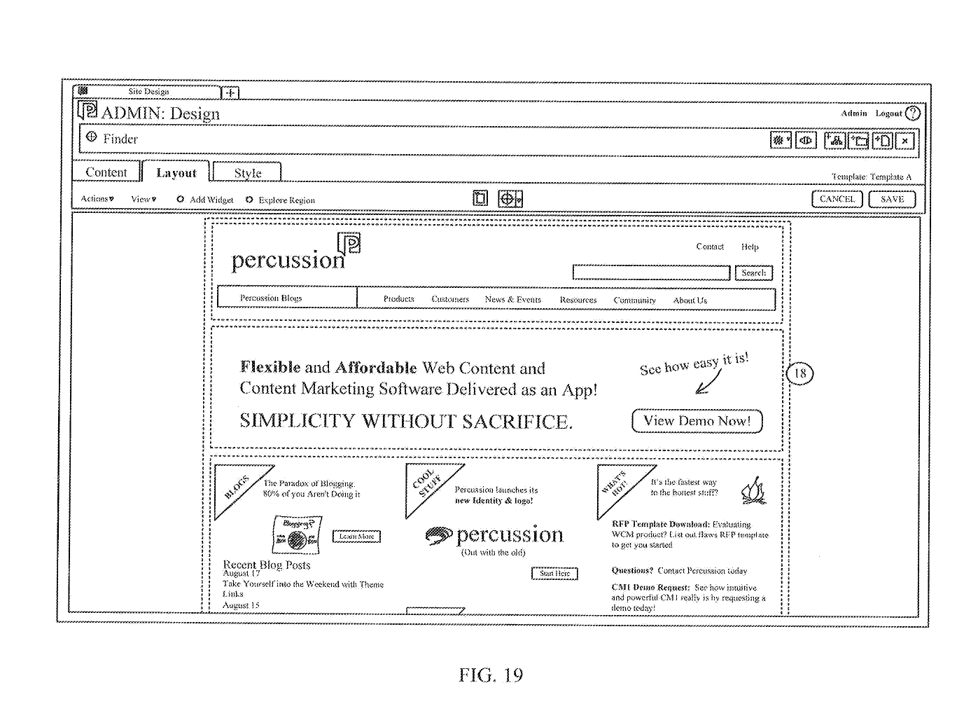

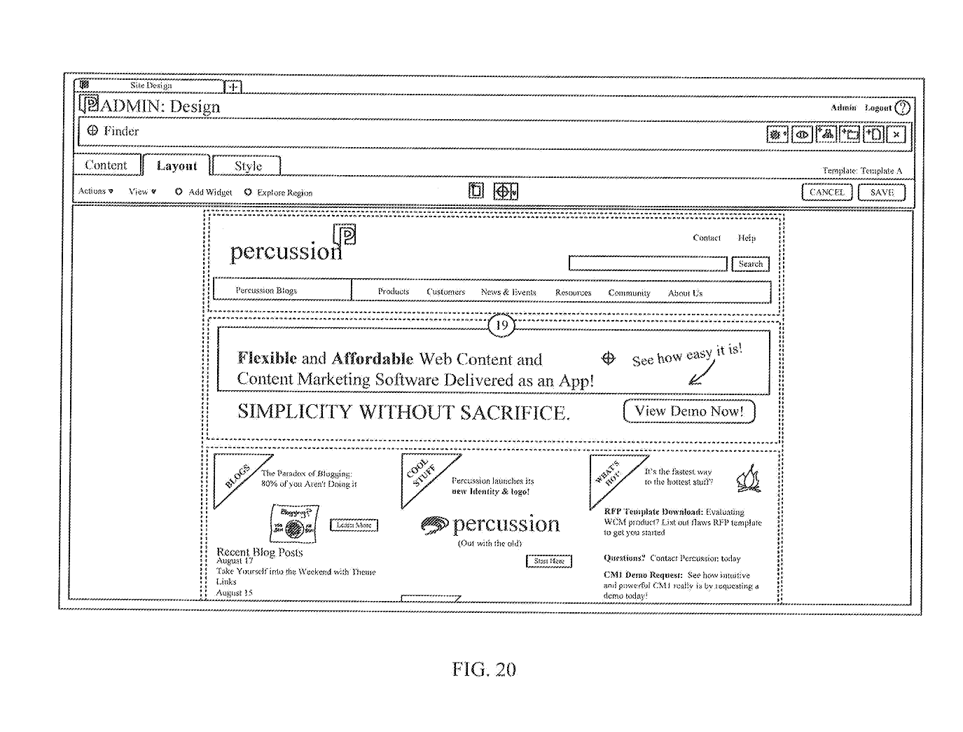

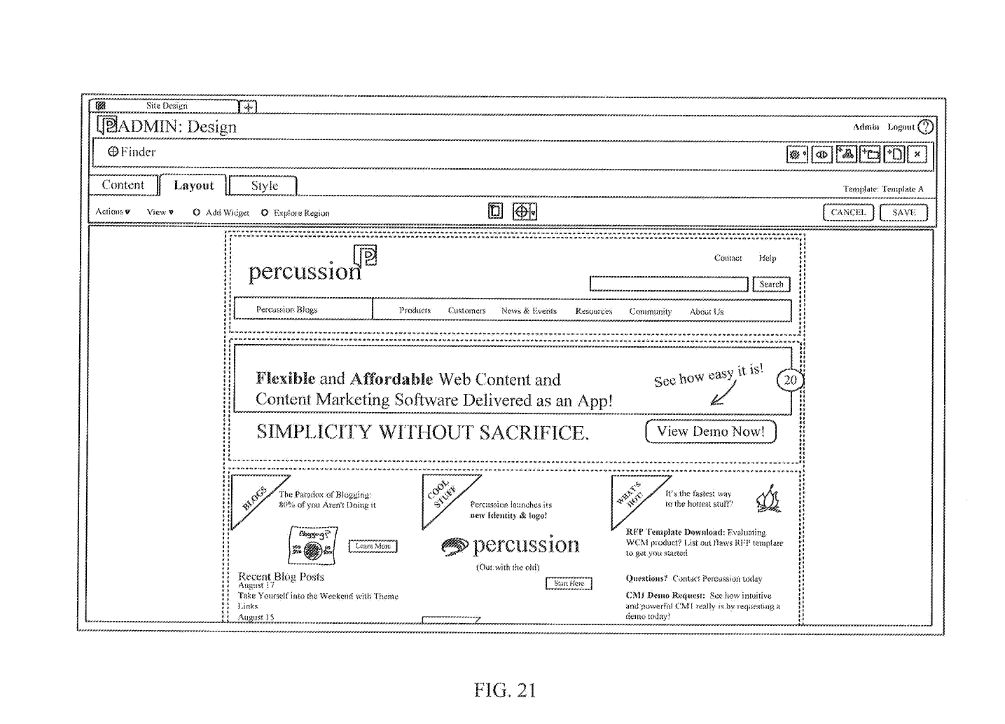

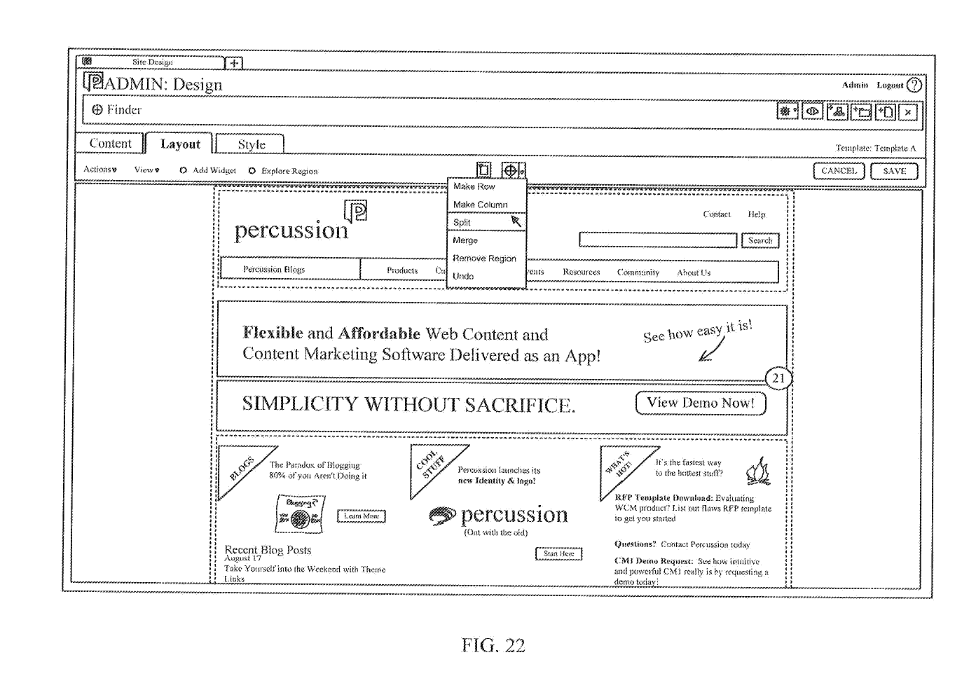

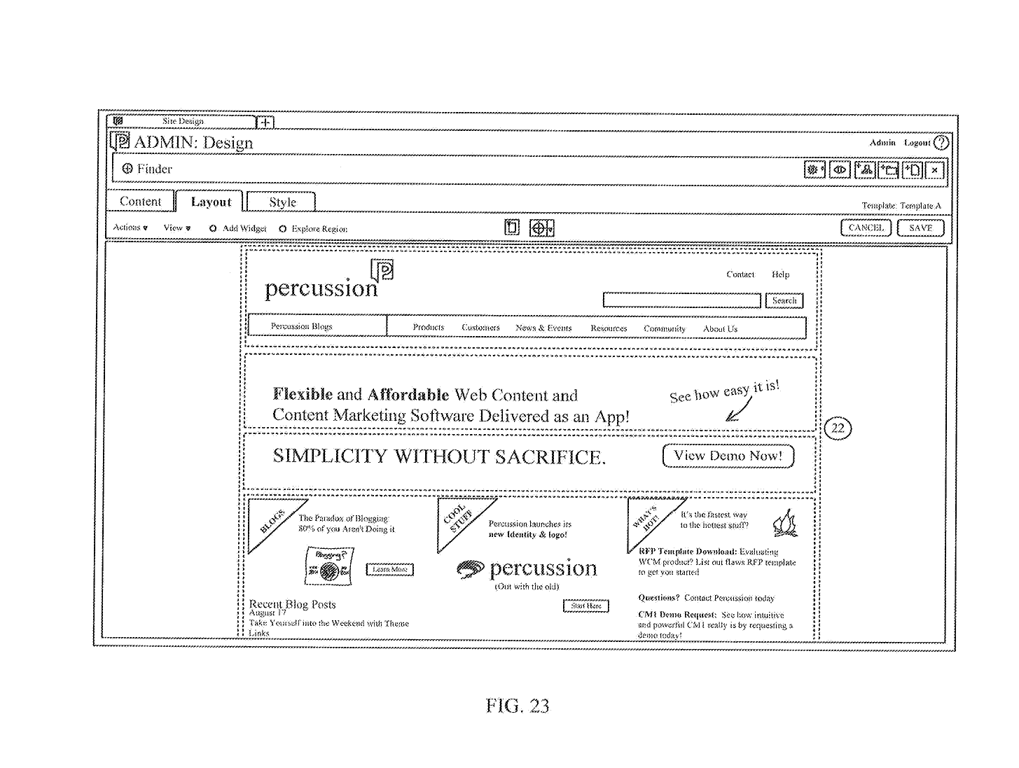

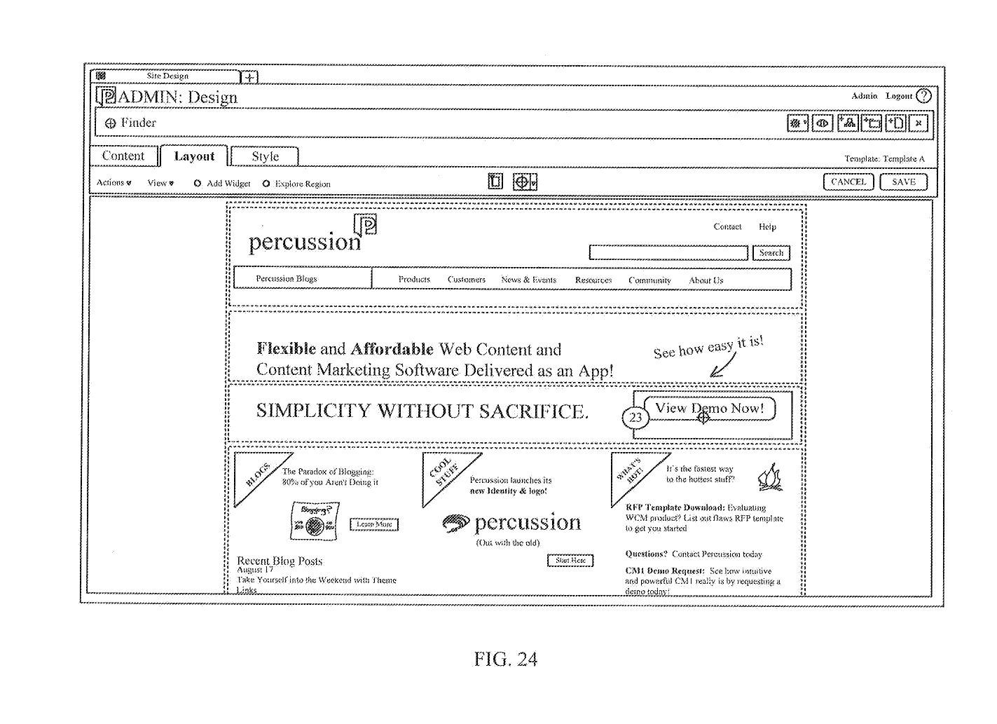

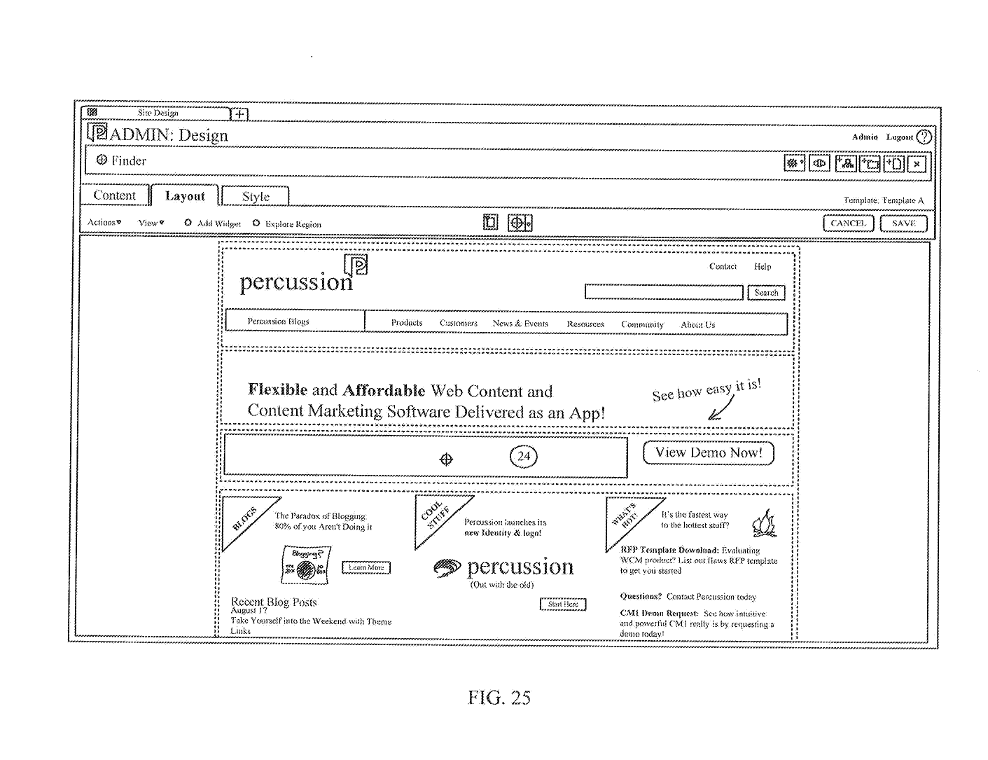

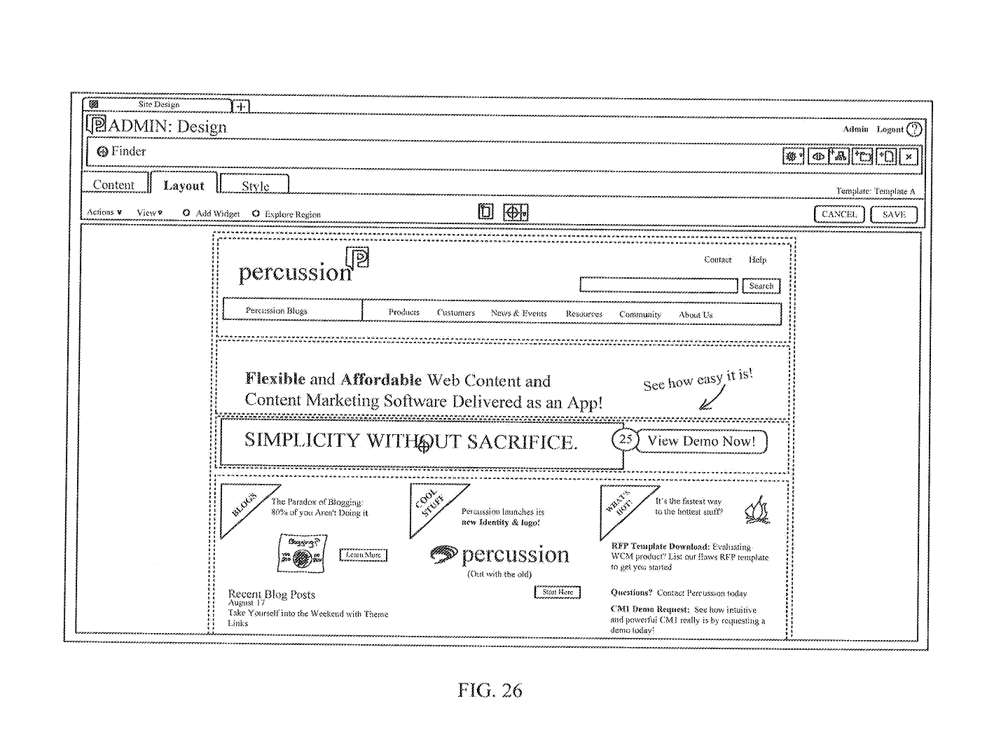

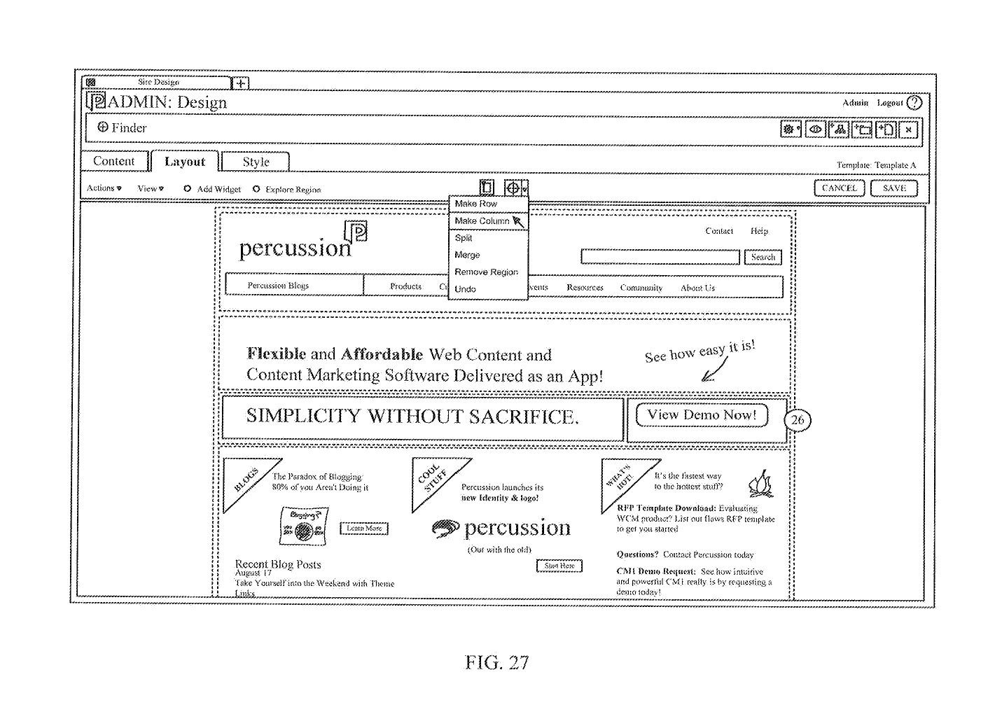

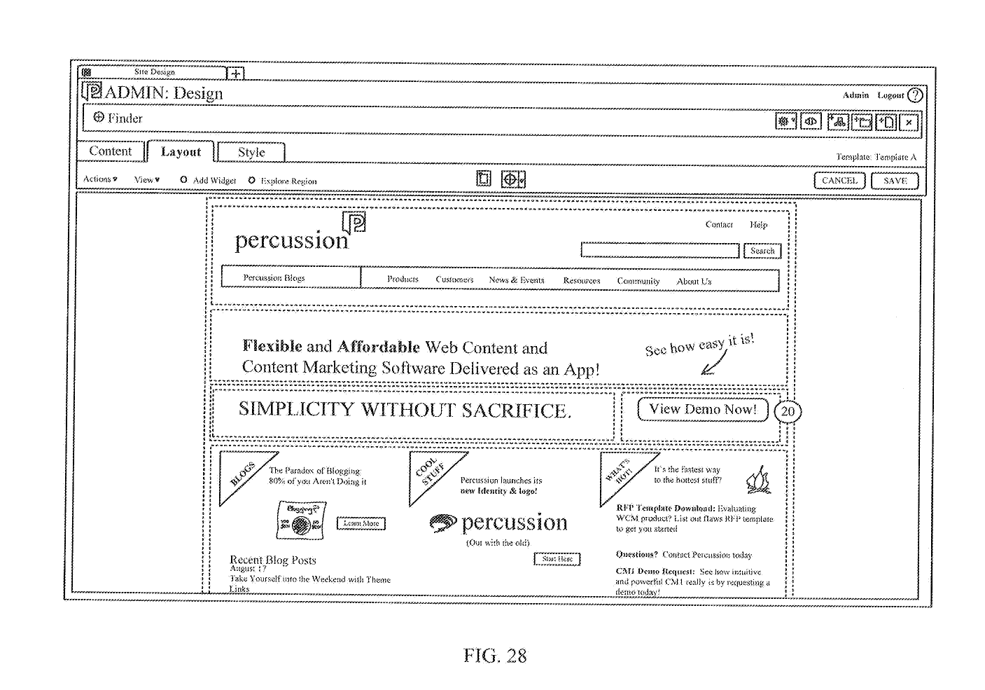

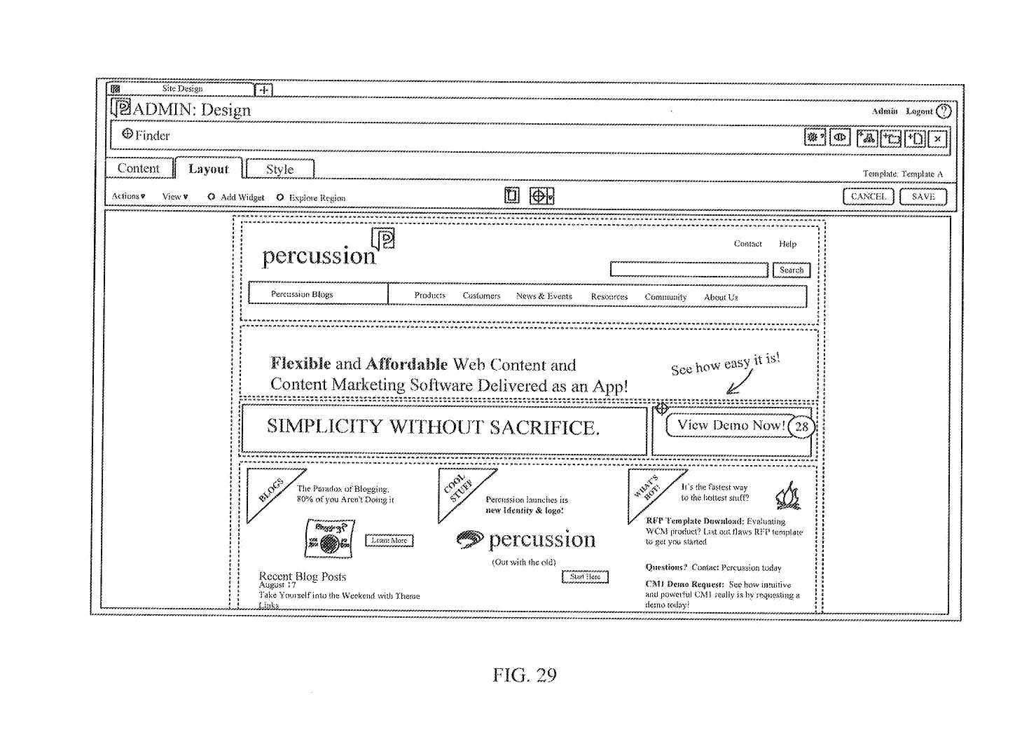

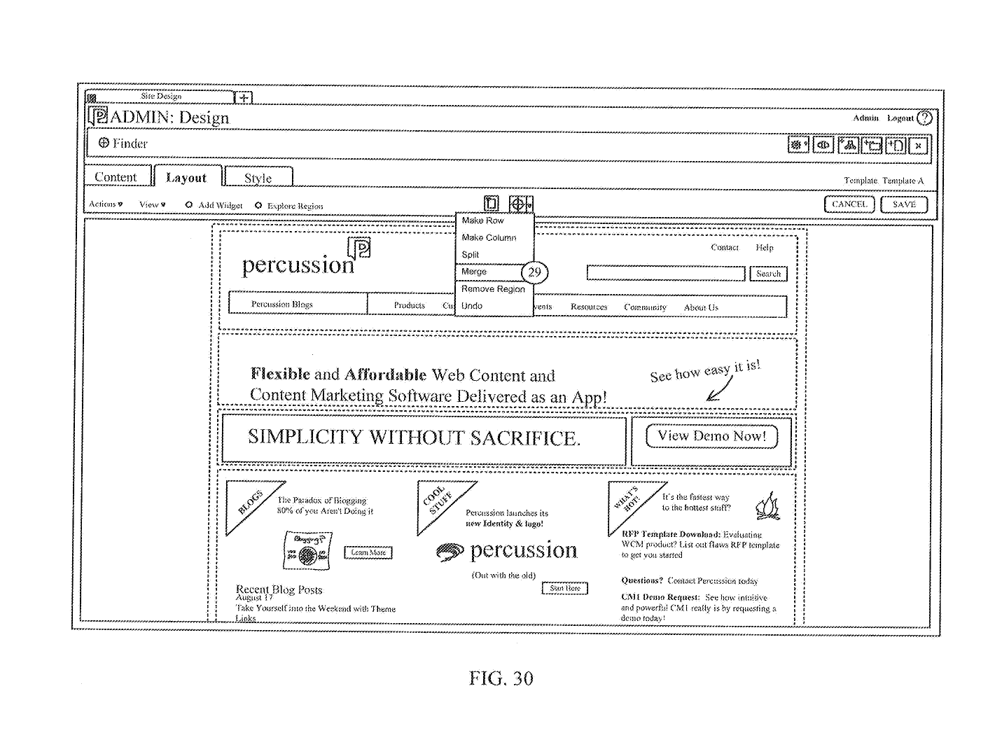

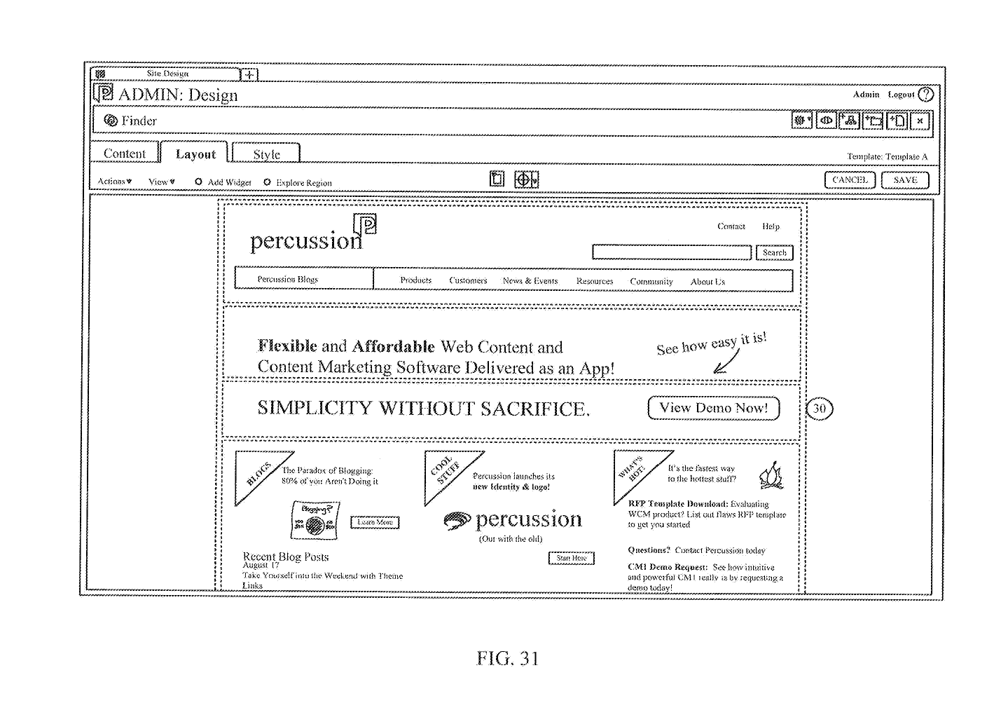

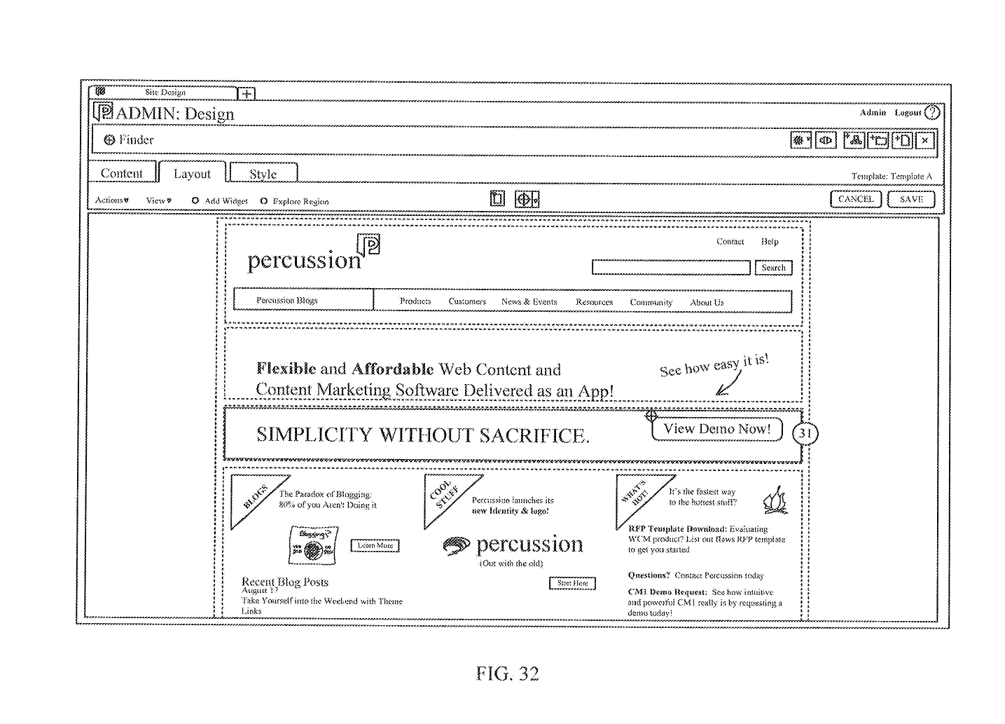

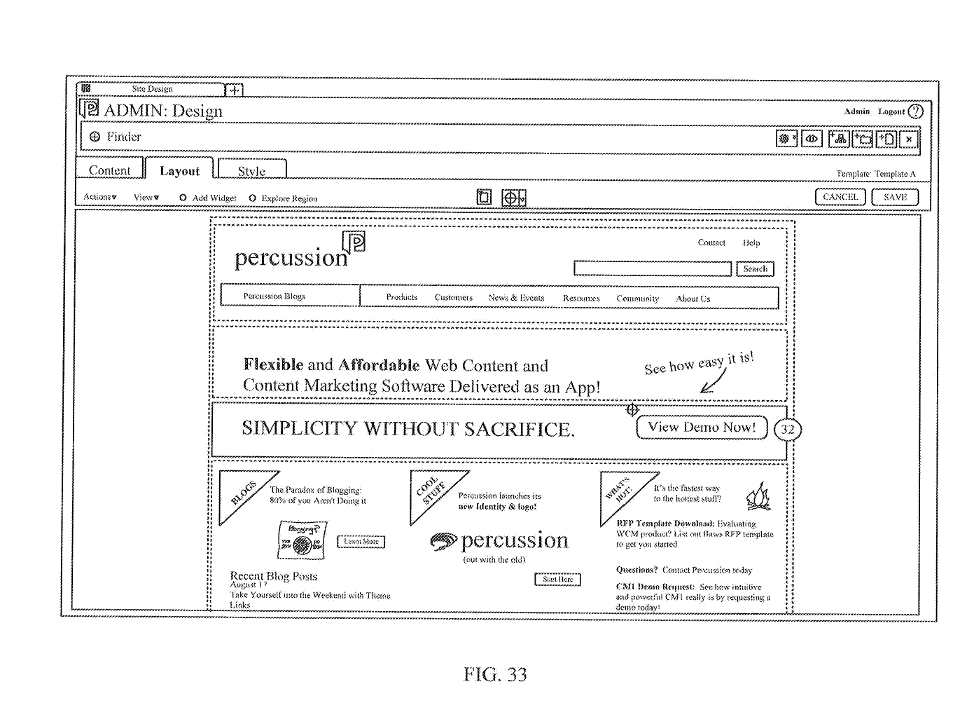

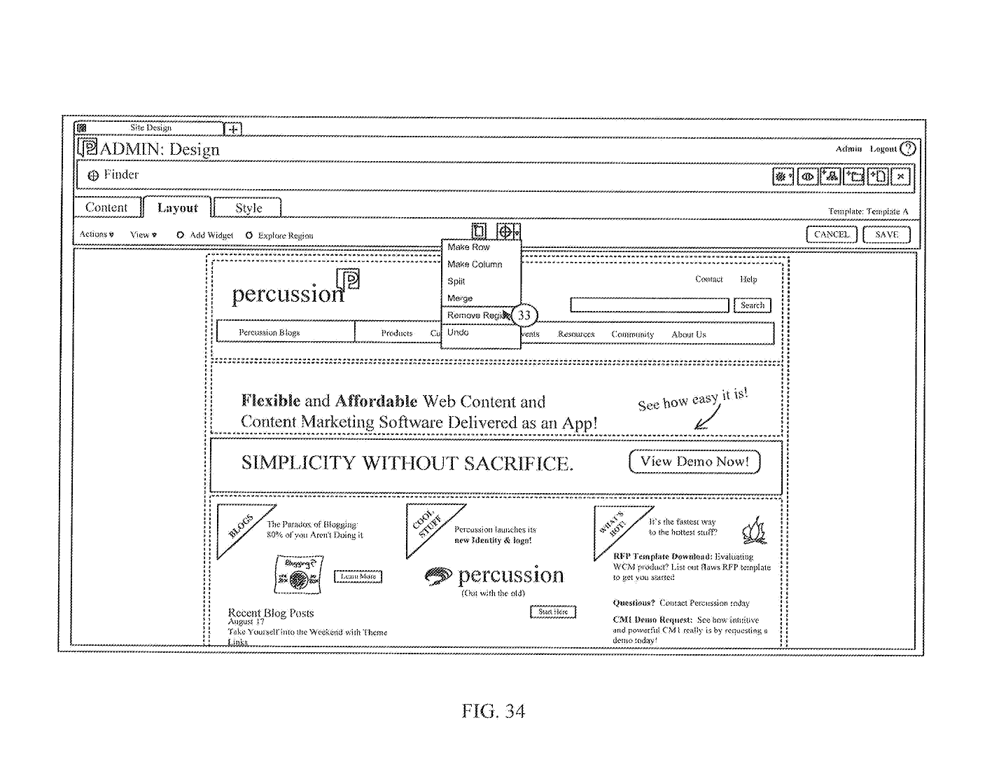

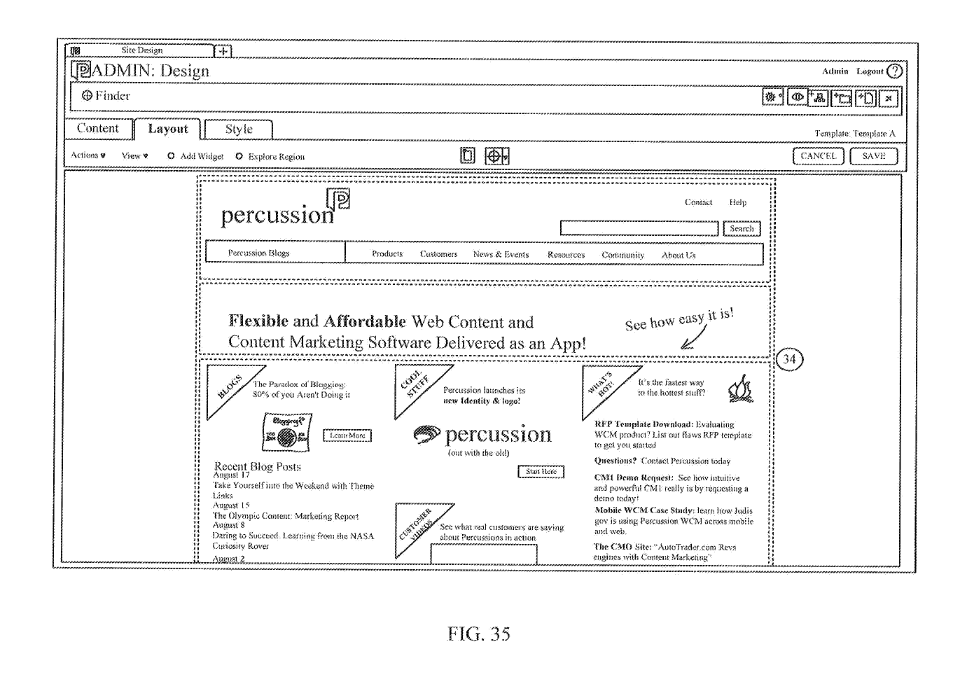

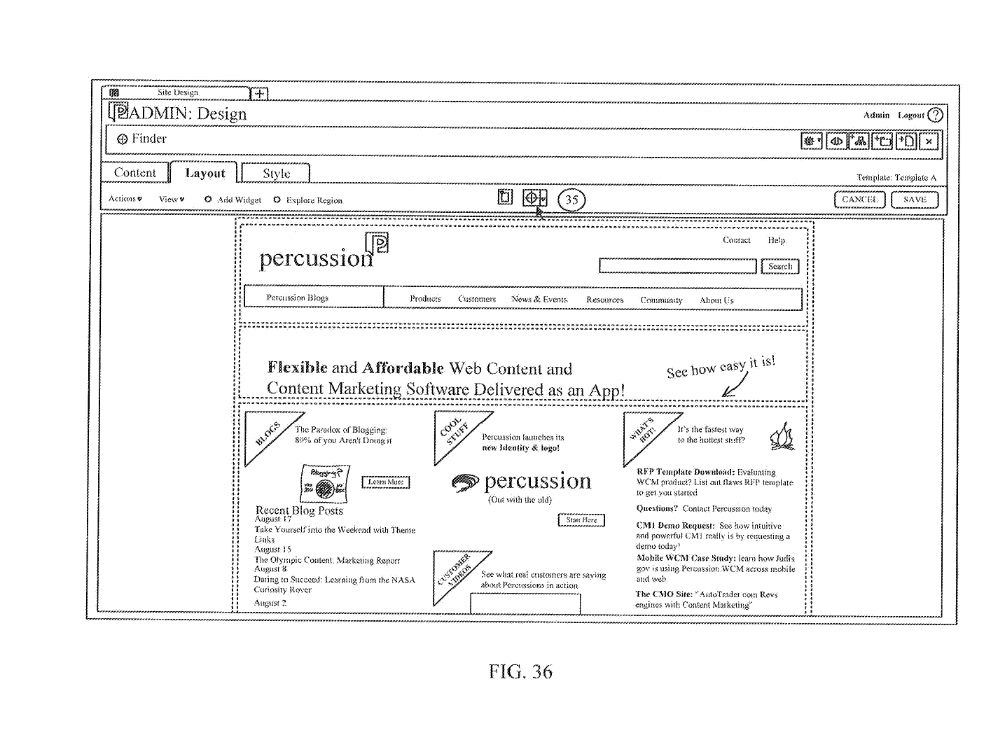

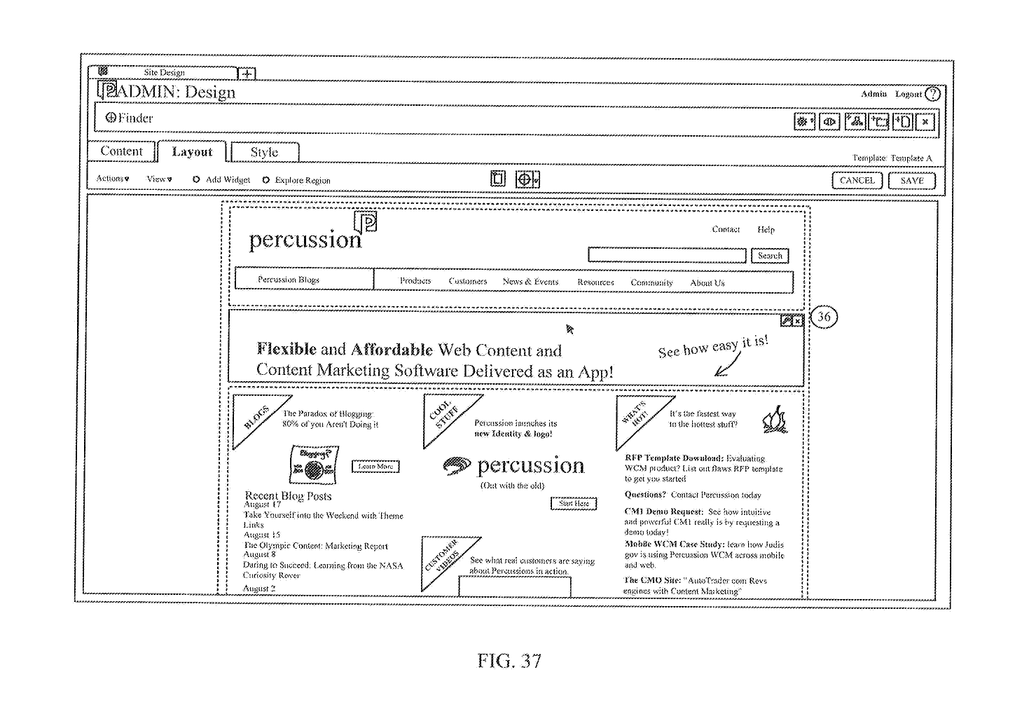

A web site URL is entered and its corresponding page is converted into a template holding the IA information and a resulting page with only the remaining HMTL content in a matching location. A series of visually intuitive steps are then followed to apply IA to the page, creating a template and a page that uses the template. This process, which is implemented as a computer application, is now described with reference to the example screen shots illustrated in FIGS. 4-37.

Initially, the user selects “Create Site” (block 1) and a “Create” dialog is displayed. With the “URL” selection button selected by default, the user may type the example URL “home.html” (block 2). The user then selects the “Next” button (block 3). The process then loads the “home.html” page. An indicator shown at block 4 is displayed letting the user know that processing is ongoing. Once the process has completed the import, the user is sent to a “Template Layout” tab whereby the user can begin editing (block 5). Colors can be used to indicate what is editable and what is not (i.e., un-editable content can be greyed out).

The user can hover over and select an “Inspection Tool” (blocks 6 and 7). When the user selects the Inspection Tool, the cursor changes to reflect that the tool is operational. The user can hover over areas to see what areas the application considers as possible regions for modification (block 8). The user selects a region (block 9). The selection can cause the area to change from one color to a second color. The user selects a drop down menu and then hovers to “Make Rows” menu item (block 10). A preview of regions to be created are displayed in another color for easy review by the user. When the user selects Make Rows, created regions are shown in a different color. The Tool remains active and the user can hover and continue to make rows, if desired (blocks 12-16). The user may “Undo” all or part of its “Make Rows” selections (blocks 17-18) and is returned to its previous state (i.e., Tool).

The user may hover to a region, select the region and then split the region (blocks 19-22). The user may hover over other possible regions, select an area, and choose “Make Column” from a drop down menu (blocks 23-26). The new regions are created and displayed (block 27). The user may select more than one region by clicking the shift key and selecting more than one region with the mouse (block 28). A “Merge” feature may be one option to merge the selected regions together (blocks 29-30). The user may hover over another region, select it and remove the region (blocks 31-34). The user can toggle off the Inspection Tool (block 35) and hover over the regions using the regular cursor (block 35). At this point the user can edit a selected region.

Part II

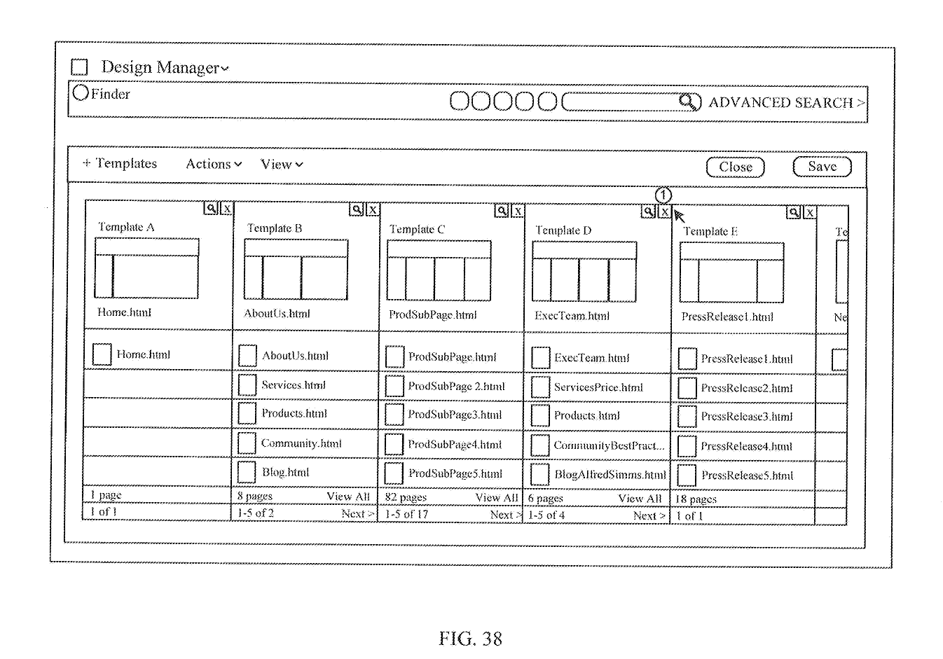

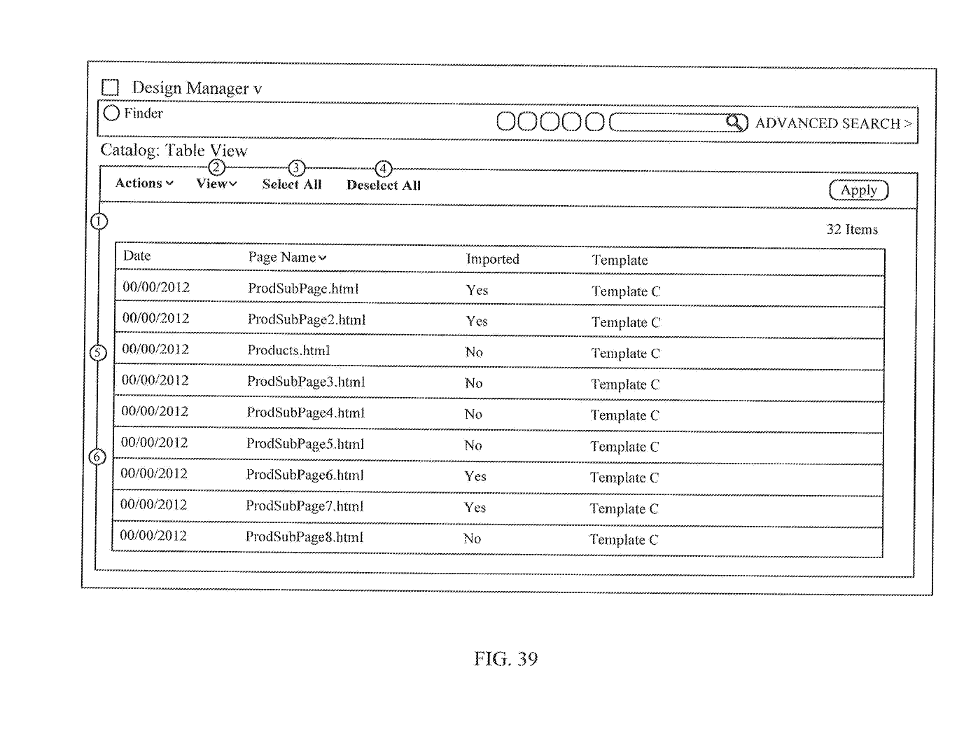

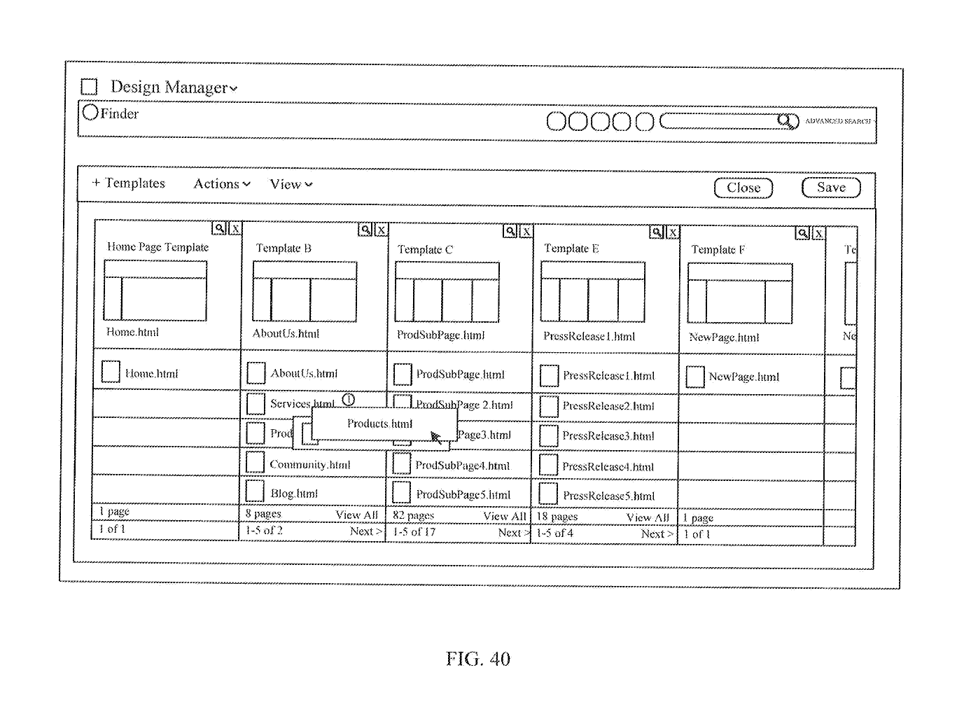

The example screens illustrated in FIGS. 38-40 show an example where a website has been cataloged. A set of possible templates A through F are created (as suggested they are stubs to start). Each set of pages that are similar are grouped in column lists below each template. The user may thus select the first page of the list to begin creating a template IA (to fill out the stub template) for that group using the steps seen in the part I example. When done, the user may select the “apply” button to apply that IA to any or all selected templates in the list. Subsequently, the user may exclude or move pages from one list to another to adjust the template IA being used. Because part I of the process has created all of the information needed to process other pages, no other end user interaction is required to “apply” them to other pages in the system. FIG. 38 shows the catalog of possible page groups, listing pages by name in columns underneath the template that could be used to define the IA of each group of pages. FIG. 39 shows the user inspecting a group of pages to select them in order to apply a template IA to them (and/or to exclude certain selected pages from processing). FIG. 40 shows a user manually moving a page from one group to another, which will cause the template IA of template C to be applied to the “products.html” page that previously had been using (or was cataloged) as using template B.

It should be appreciated that this application of a template IA can also be applied to a page on a one off-case by case basis, or changed later in the life of the application as the web changes and user needs to apply new IA or change the IA of existing pages over and over.

### Environment

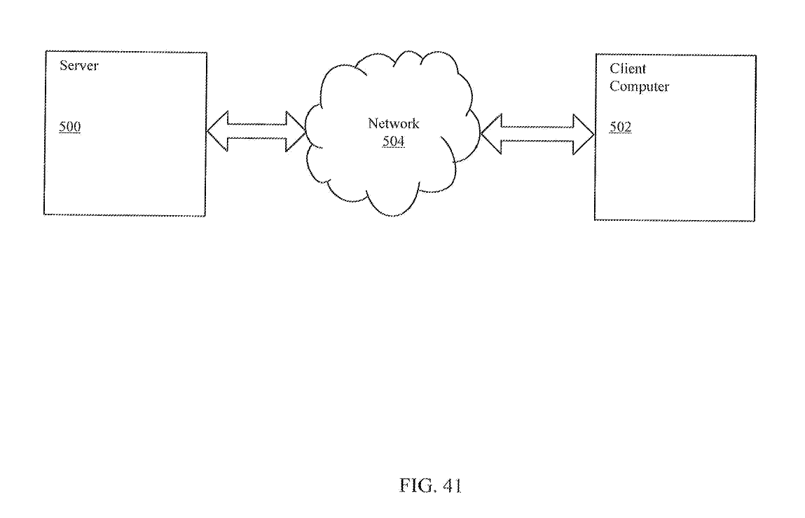

Referring to FIG. 41, some embodiments may be implemented as an application running on a computer such as a server 500 that can be accessed by a client computer 502 (e.g., a personal computer or a workstation) using a browser (e.g., Internet Explorer) through a network 504 (e.g., the Internet). The server on which the application is running may or may not be the same server that hosts the website.

Computers may be linked to one another via a network or networks. A computer may be any programmable machine (or collection of machines) capable of performing arithmetic and/or logical operations. In some embodiments, computers may comprise processors, memories, data storage devices, interfaces and/or other commonly known or novel components. These components may be connected physically or through network or wireless links. Computers may also comprise software which may direct the operations of the aforementioned components. Computers may be referred to with terms that are commonly used by those of ordinary skill in the relevant arts, such as servers, PCs, mobile devices, and other terms. It will be understood by those of ordinary skill that those terms used herein are interchangeable, and any computer capable of performing the described functions may be used. For example, though the term “server” may appear in the following specification, the disclosed embodiments are not limited to servers.

A network may be any plurality of completely or partially interconnected computers wherein some or all of the computers are able to communicate with one another. It will be understood by those of ordinary skill that connections between computers may be wired in some cases (i.e. via Ethernet, coaxial, optical, or other wired connection) or may be wireless (i.e. via WiFi, WiMax, or other wireless connection). Connections between computers may use any protocols, including connection oriented protocols such as TCP or connectionless protocols such as UDP. Any connection through which at least two computers may exchange data can be the basis of a network. Some networks, may be geographically spread out, with nodes located in data centers in various locations. The nodes may each comprise one or more servers. Nodes may be arranged into logical groups, which may correspond to data center placement or may be based on some other grouping scheme. Individual computers attempting to connect to network servers may connect to one or more nodes associated with a particular logical group.

1. A computer implemented method of applying new digital content to an existing page to create a new page, said method comprising:
providing a visual in situ interface for applying information architecture to the existing page;
receiving, at a processor via the interface, a request to create updated content for the existing page;
implementing a set of recursive steps whereby inputted user modifications are rendered using a first page while content of the existing page are saved in a second page;
analyzing the first and second pages and determining possible changes for the existing page;
rendering the suggested changes to suggest information architecture choices based on the analysis; and
rendering the new page based on the inputted user modifications and selections of the suggested changes.

2. The method of claim 1, wherein the first page is a template page that is stored separately from the second page.

3. The method of claim 1, wherein a page head element of the existing page is transferred to the template and a body element of the existing page is rendered through the second page.

4. The method of claim 1, wherein the first page is a template page and said method further comprises rendering the second page using the template as a preview of the new page.

5. The method of claim 4, wherein said steps of analyzing and rendering the suggested changes comprise:
determining possible elements that can add information architecture organization to the existing page;
visually displaying the possible elements;
inputting a selection of one or more of the possible elements;
applying the selection to the template; and
rendering the template and second page together to display information architecture changes and content simultaneously.

6. The method of claim 5, wherein the determining step is performed in an outside in and top down hierarchal manner.

7. The method of claim 1, wherein the first page is template and said method further comprises using the template in a bulk application process to apply information architecture to additional pages.

8. The method of claim 7, wherein said bulk application process comprises:
retrieving an annotated copy of the existing page;
defining path elements based on where the information architecture was added to the existing page;
extracting matching elements from the additional pages based on the path elements;
creating a new page object comprising the matching elements; and
rendering the additional pages through the template.

9. The method of claim 8, further comprising:
determining possible pages to be modified;
comparing the possible pages to the annotated copy of the existing page;
displaying a list of possible pages, the possible pages on the list being ordered based on similarity to the annotated copy;
inputting user selections of possible pages to apply the template to.

10. The method of claim 8, further comprising:
determining possible pages to be modified;
comparing the structure of each possible page to each other;
determining how similar each possible page is to each other;
creating a catalog of possible pages based on the determined similarity of the possible pages, the catalog including groups of possible pages; and
for each group of pages in the catalog, displaying the possible pages and inputting user selections to create a new template.

11. A computer system for applying new digital content to an existing page to create a new page, said system comprising:
a server, said server being configured to:
provide a visual in situ interface for applying information architecture to the existing page;
receive via the interface a request to create updated content for the existing page;
implement a set of recursive steps whereby inputted user modifications are rendered using a first page while content of the existing page are saved in a second page;
analyze the first and second pages and determining possible changes for the existing page;
render the suggested changes to suggest information architecture choices based on the analysis; and
render the new page based on the inputted user modifications and selections of the suggested changes.

12. The system of claim 11, wherein the first page is a template page that is stored separately from the second page.

13. The system of claim 11, wherein the first page is a template page and said server is further configured to render the second page using the template as a preview of the new page.

14. The system of claim 13, wherein said server performs the steps of analyzing and rendering the suggested changes by:
determining possible elements that can add information architecture organization to the existing page;
visually displaying the possible elements;
inputting a selection of one or more of the possible elements;
applying the selection to the template; and
rendering the template and second page together to display information architecture changes and content simultaneously.

15. The system of claim 14, wherein the server determines possible elements by performing an outside in and top down hierarchal process.

16. The system of claim 11, wherein the first page is template and said method further comprises using the template in a bulk application process to apply information architecture to additional pages.

17. The system of claim 16, wherein said bulk application process comprises:
retrieving an annotated copy of the existing page;
defining path elements based on where the information architecture was added to the existing page;
extracting matching elements from the additional pages based on the path elements;
creating a new page object comprising the matching elements; and
rendering the additional pages through the template.

18. The system of claim 17, further comprising:
determining possible pages to be modified;
comparing the possible pages to the annotated copy of the existing page;
displaying a list of possible pages, the possible pages on the list being ordered based on similarity to the annotated copy;
inputting user selections of possible pages to apply the template to.

19. The system of claim 17, further comprising:
determining possible pages to be modified;
comparing the structure of each possible page to each other;
determining how similar each possible page is to each other;
creating a catalog of possible pages based on the determined similarity of the possible pages, the catalog including groups of possible pages; and
for each group of pages in the catalog, displaying the possible pages and inputting user selections to create a new template.
